(19) United States
(12) Patent Application Publication
(10) Pub. No.: US 2025/0066937 A1
(43) Pub. Date: Feb. 27, 2025

(54) ELECTROCATALYST COATED ELECTRODE FOR WATER ELECTROLYSIS AND METHOD OF PRODUCING SAME

(71) Applicant: Verdagy, Inc., Moss Landing, CA (US)

(72) Inventors: Kevin M. Cole, Santa Cruz, CA (US); Emily A. Cole, Monterey, CA (US); Emily Pond, Pacific Grove, CA (US); Ashton Robert Reinhold, Aptos, CA (US)

(21) Appl. No.: 18/813,739

(22) Filed: Aug. 23, 2024

Related U.S. Application Data
(60) Provisional application No. 63/578,863, filed on Aug. 25, 2023.

(51) Int. Cl. C25B 11/077; C25B 1/04; C25B 11/031; C25B 11/063

(52) U.S. Cl. CPC C25B 11/0771; C25B 1/04; C25B 11/031; C25B 11/063

(57) ABSTRACT

A method comprises coprecipitating one or more precursor compounds from a solution comprising one or more first metal salts and one or more second salts to produce precipitated precursor particles, forming a slurry of the precipitated precursor particles, applying the slurry to one or more surfaces of a conductive substrate to provide a slurry coated substrate, and baking the slurry coated substrate at specified calcination conductions to convert the one or more precursor compounds of the precipitated precursor particles to spinel particles that are adhered to the one or more surfaces of the conductive substrate, wherein the spinel particles comprise a spinel with the general chemical formula AB₂O₄.

### CROSS-REFERENCE TO RELATED APPLICATION

This application claims priority under 35 U.S.C. § 119(e) to U.S. Provisional Application Ser. No. 63/578,863, filed on Aug. 25, 2023, entitled “ELECTROCATALYST COATED ELECTRODE FOR WATER ELECTROLYSIS AND METHOD OF PRODUCING SAME,” the disclosure of which is incorporated herein by reference in its entirety.

### BACKGROUND

The production of hydrogen can play an important role because hydrogen gas is required for many chemical processes. As of 2022, roughly 75 million tons of hydrogen is produced annually worldwide for various uses, such as oil refining, in the production of ammonia (through the Haber process), in the production of methanol (though reduction of carbon monoxide), or as a fuel in transportation.

Historically, a large majority of hydrogen (˜95%) has been produced from fossil fuels (e.g., by steam reforming of natural gas, partial oxidation of methane, or coal gasification). Other methods of hydrogen production include biomass gasification, low- or no-CO₂ emission methane pyrolysis, and electrolysis of water. Electrolysis uses electricity to split water molecules into hydrogen gas and oxygen gas. To date, electrolysis systems and methods have been generally more expensive than fossil-fuel based production methods. However, the fossil-fuel based methods can be more environmentally damaging, generally resulting in increased CO₂ emissions. Therefore, there is a need for cost-competitive and environmentally friendly methods of hydrogen gas producing electrolysis systems and methods.

### SUMMARY

The present disclosure describes a catalyst coated electrode for use in an electrochemical device, such as a water electrolyzer for the production of hydrogen gas (H₂). In an example, the catalyst comprises one or more of a mixed metal oxide, a metal alloy oxide (including a metal hydroxide or a metal oxyhydroxide), or a metal-metalloid alloy. The catalyst comprises a material having a spinel crystalline structure.

The present disclosure also describes a method of producing a catalyst coated electrode, which includes coprecipitation of a nitrate salt or salts with a chloride salt or salts from an alkaline solution to provide coprecipitated catalyst precursor particles. In some examples, the alkaline solution includes a surfactant, which can result in smaller particle size for the coprecipitated precursor particles. The coprecipitated catalyst precursor particles are mixed with a carrier liquid to produce a slurry, which can be directly applied to an electrode substrate via a slurry application process, such as dip coating, painting, doctor blade application, slot die coating, comma bar coating, or application with a tensioned web. The coated electrode substrate is then heated at a specified temperature to convert the one or more precursor compounds to a spinel catalyst structure that forms directly on the one or more surfaces of the electrode substrate.

In an example, the present disclosure describes a method comprising coprecipitating one or more precursor compounds from a solution comprising one or more first salts comprising one or more nitrates, one or more second salts comprising one or more chlorides, and (optionally) a surfactant, to produce precipitated precursor particles of the one or more precursor compounds, forming a slurry of the precipitated precursor particles, applying the slurry to one or more surfaces of a conductive substrate to provide a slurry coated substrate, and baking the slurry coated substrate at specified calcination conductions to convert the one or more precursor compounds to spinel particles that are adhered directly to the one or more surfaces of the conductive substrate, wherein the spinel particles have a spinel crystal structure with the general chemical formula AB₂O₄.

In an example, the present disclosure describes an electrode composite comprising a conductive substrate, and a spinel catalyst coating comprising spinel particles adhered directly to one or more surfaces of the conductive substrate without the use of a separate binder or adhesive, wherein the spinel particles have a spinel crystal structure with the general chemical formula AB₂O₄.

### BRIEF DESCRIPTION OF THE FIGURES

The drawings illustrate generally, by way of example, but not by way of limitation, various embodiments discussed in the present document.

FIG. 1 is a schematic diagram of an example electrolyzer cell for the electrolysis of water to produce hydrogen gas.

FIG. 2 is a cross-sectional view of an example electrolyzer cell comprising an anode pan assembly and a cathode pan assembly separated by a separator.

FIG. 3 is a close-up cross-sectional view of an example anode assembly and cathode assembly of the example electrolyzer cell of FIG. 2.

FIG. 4 is a plan view of a woven mesh electrode with a catalyst coating to provide a catalyst coated electrode.

FIG. 5 is a cross-sectional view of the catalyst coated electrode of FIG. 4 taken along line 5-5.

FIGS. 6-9 are plan view and cross-sectional views of mesh electrodes formed from various examples of weaving patterns and that have been coated with a catalyst coating to provide catalyst coated electrodes.

FIG. 10 is a close-up cross-sectional view of a surface of an example conductive substrate of an electrode with spinel particles adhered directly to the surface of the conductive substrate.

FIG. 11 is a flow diagram of an example method of making a conductive substrate coated with spinel particles adhered directly to one or more surfaces of the conductive substrate.

FIGS. 12A-12C are scanning electron microscopy (SEM) image of spinel catalyst particles formed by coprecipitation from various solutions followed by calcination. FIG. 12A shows the particles formed by coprecipitation from a solution comprising only nitrate salts with no surfactant.

FIG. 12B shows the particles formed by coprecipitation from a solution comprising a surfactant and only nitrate salts. FIG. 12C shows the particles formed by coprecipitation from a solution comprising nitrate salt, chloride salt, and a surfactant.

FIGS. 13A-13D are X-ray diffraction (XRD) fitting patterns for spinel particle samples formed by coprecipitation from various solutions followed by calcination at various temperatures. FIGS. 13A and 13B show XRD patterns for particles formed by coprecipitation from a solution of nickel nitrate, cobalt chloride, and a surfactant followed by calcination at 325° C. and 200° C., respectively. FIG. 13C shows the XRD pattern for particles formed by coprecipitation from a solution comprising nickel nitrate, copper nitrate, and cobalt chloride followed by calcination at 350° C. FIG. 13D shows the XRD pattern for particles formed by coprecipitation from a solution comprising nickel nitrate, copper nitrate, and cobalt nitrate followed by calcination at 350° C.

FIGS. 14A-14C show optical images of a bare (uncoated) nickel mesh electrode at a macro scale (FIG. 14A), at 4× magnification (FIG. 14B), and at 10× magnification (FIG. 14C).

FIGS. 15A-15C show optical images of a nickel mesh electrode coated with catalyst particles by conventional spray coating at a macro scale (FIG. 15A), at 4× magnification (FIG. 15B), and at 10× magnification (FIG. 15C).

FIGS. 16A-16C show optical images of a nickel mesh electrode coated with catalyst particles by the coprecipitation and direct baking methods of the present disclosure at a macro scale (FIG. 65A), at 4× magnification (FIG. 16B), and at 10× magnification (FIG. 16C).

### DETAILED DESCRIPTION

The following detailed description includes references to the accompanying drawings, which form a part of the detailed description. The drawings show, by way of illustration, specific embodiments in which the invention may be practiced. These embodiments, which are also referred to herein as “examples,” are described in enough detail to enable those skilled in the art to practice the invention. The example embodiments may be combined, other embodiments may be utilized, or structural, and logical changes may be made without departing from the scope of the present invention. While the disclosed subject matter will be described in conjunction with the enumerated claims, it will be understood that the exemplified subject matter is not intended to limit the claims to the disclosed subject matter. The following detailed description is, therefore, not to be taken in a limiting sense, and the scope of the present invention is defined by the appended claims and their equivalents.

References in the specification to “one embodiment,” “an embodiment,” “an example embodiment,” etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a recited range of values of “about 0.1 to about 5” should be interpreted to include not only the explicitly recited values of about 0.1 and about 5, but also all individual concentrations within the indicated range of values (e.g., 1, 1.23, 2, 2.85, 3, 3.529, and 4, to name just a few) as well as sub-ranges that fall within the recited range (e.g., about 0.1 to about 0.5, about 1.21 to about 2.36, about 3.3 to about 4.9, or about 1.2 to about 4.7, to name just a few). The statement “about X to Y” has the same meaning as “about X to about Y,”” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. Unless indicated otherwise, the statement “at least one of” when referring to a listed group is used to mean one or any combination of two or more of the members of the group. For example, the statement “at least one of A, B, and C” can have the same meaning as “A; B; C; A and B; A and C; B and C; or A, B, and C,” or the statement “at least one of D, E, F, and G” can have the same meaning as “D; E; F; G; D and E; D and F; D and G; E and F; E and G: F and G; D, E, and F; D, E, and G; D, F, and G; E, F, and G; or D, E, F, and G.” A comma can be used as a delimiter or digit group separator to the left or right of a decimal mark; for example, “0.000,1″” is equivalent to “0.0001.”

In the methods described herein, the steps can be carried out in any order without departing from the principles of the invention, except when a temporal or operational sequence is explicitly recited. Furthermore, specified steps can be carried out concurrently unless explicit language recites that they be carried out separately. For example, a recited act of doing X and a recited act of doing Y can be conducted simultaneously within a single operation, and the resulting process will fall within the literal scope of the process. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E (including with one or more steps being performed concurrent with step A or Step E), and that the sequence still falls within the literal scope of the claimed process. A given step or sub-set of steps can also be repeated.

Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

The term “about” as used herein can allow for a degree of variability in a value or range, for example, within 10%, within 5%, within 1%, within 0.5%, within 0.1%, within 0.05%, within 0.01%, within 0.005%, or within 0.001% of a stated value or of a stated limit of a range, and includes the exact stated value or range.

The term “substantially” as used herein refers to a majority of, or mostly, such as at least about 50%, 60%, 70%, 80%, 90%, 95%, 96%, 97%, 98%, 99%, 99.5%, 99.9%, 99.99%, or at least about 99.999% or more, or 100%.

In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

Hydrogen gas (H₂) can be formed electrochemically by a water-splitting reaction where water is split into oxygen gas (O₂) and H₂ gas at an anode and a cathode of an electrochemical cell, respectively. Examples of such electrochemical processes include, without limitation, proton electrolyte membrane (PEM) electrolysis and alkaline water electrolysis (AWE). In such electrochemical reactions, the operating energy necessary to drive the water-splitting electrolysis reaction is high due to additional energy costs as a result of various energy inefficiencies. For example, to reduce unwanted migration of ionic species between the electrodes, the cathode and the anode may be separated by a separator, such as a membrane, which can reduce migration of the ionic species. Although the separator can improve the overall efficiency of the cell, it can come at a cost of additional resistive losses in the cell, which in turn increases the operating voltage. Other inefficiencies in water electrolysis can include solution resistance losses, electric conduction inefficiencies, and/or electrode over-potentials, among others.

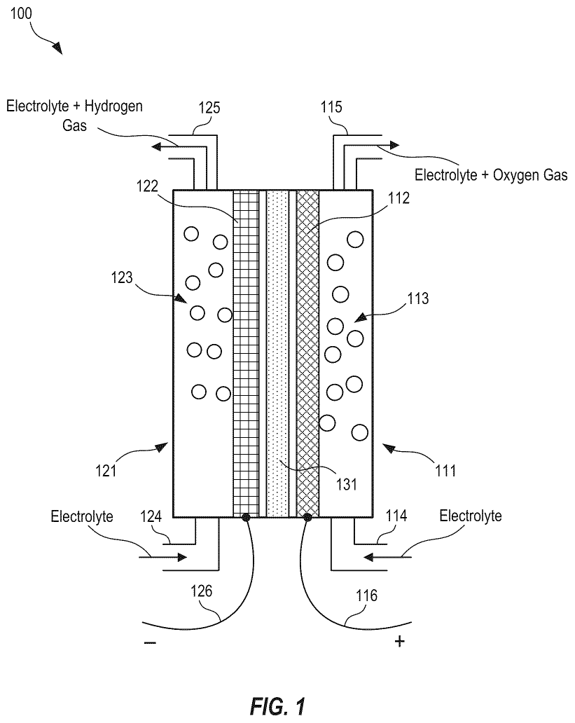

FIG. 1 is a schematic diagram of a generic water electrolyzer cell 100 that converts water (H₂O) into hydrogen gas (H₂) and oxygen gas (O₂) with electrical power. In an example, the electrolyzer cell 100 comprises a housing, e.g., an overall chassis structure that defines and at least partially encloses an interior of the cell 100. The housing can divide the cell 100 into two half cells: a first half cell 111 and a second half cell 121. In an example, the first and second half cells 111, 121 are separated by a separator 131, such as a membrane 131. In an example, the separator 131 comprises a porous membrane (e.g., a microporous membrane or a nanoporous membrane), an ion-exchange membrane, or an ion solvating membrane. In examples wherein the separator 131 comprises an ion-exchange membrane, the membrane can be of different types, such as an anion exchange membrane (AEM), a cation exchange membrane (CEM), a proton exchange membrane (PEM), or a bipolar ion exchange membrane (BEM).

In examples where the separator 131 is a cation exchange membrane, the cation exchange membrane can be a conventional membrane such as those available from, for example, Asahi Kasei Corp. of Tokyo, Japan, or from Membrane International Inc. of Glen Rock, NJ, USA, or from The Chemours Company of Wilmington, DE, USA. Examples of cation exchange membranes include, but are not limited to, the membrane sold under the N2030WX trade name by The Chemours Company and the membrane sold under the F8020/F8080 or F6801 trade names by the Asahi Kasei Corp. Examples of materials that can be used to form a cationic exchange membrane include, but are not limited to, a perfluorinated polymer containing anionic groups, for example sulphonic and/or carboxylic groups. It may be appreciated, however, that in some examples, depending on the need to restrict or allow migration of a specific cation or an anion species between the electrolytes, a cation exchange membrane that is more restrictive and thus allows migration of one species of cations while restricting the migration of another species of cations may be used. Similarly, in some embodiments, depending on the need to restrict or allow migration of a specific anion species between the electrolytes, an anion exchange membrane that is more restrictive and thus allows migration of one species of anions while restricting the migration of another species of anions may be used. Such restrictive cation exchange membranes and anion exchange membranes are commercially available and can be selected by one ordinarily skilled in the art.

In some examples, the separator 131 can be selected so that it can function in an acidic and/or an alkaline electrolytic solution, as appropriate. Other properties for the separator 131 that may be desirable include, but are not limited to, high ion selectivity, low ionic resistance, high burst strength, and high stability in electrolytic solution in a temperature range of room temperature to 150° C. or higher.

In an example, the separator 131 is stable in a temperature range of from about 0° C. to about 150° C., for example from about 0° C. to about 100° C., such as from about 0° C. to about 90° C., for example from about 0° C. to about 80° C., such as from about 0° C. to about 70° C., for example from about 0° C. to about 60° C., such as from about 0° C., to about 50° C., for example from about 0° C. to about 40° C., or such as from about 0° C. to about 30° C.

It may be useful to use an ion-specific ion exchange membrane that allows migration of one type of ion (e.g., cation for a CEM and anion for an AEM) but not another, or migration of one type of ion and not another, to achieve a desired product or products in the electrolyte solution.

In an example, the first half cell 111 comprises a first electrode 112, which can be placed proximate to the separator 131, and the second half cell 121 comprises a second electrode 122, which can be placed proximate to the separator 131, for example on an opposite side of the separator 131 from the first electrode 112. In an example, the first electrode 112 is the anode for the electrolyzer cell 100 and the second electrode 122 is the cathode for the electrolyzer cell 100, such that for the remainder of the present disclosure the first half cell 111 may also be referred to as the anode half cell 111, the first electrode 112 may also be referred to as the anode 112, the second half cell 121 may also be referred to as the cathode half cell 121, and the second electrode 122 may also be referred to as the cathode 122. In an example, each electrode 112, 122 can comprise a high surface area metal, such as a fine metal mesh. In an example, each electrode 112, 122 comprises a nickel mesh.

The electrodes 112, 122 are the locations of the cell 100 where the electron transfer reactions occur—e.g., oxidation of OH⁻ at the anode 112 to produce O₂ gas or reduction of H₂O at the cathode 122 to produce H₂ gas. Each of the electrodes 112, 122 can be coated with one or more electrocatalysts to speed the reaction toward the hydrogen gas (H₂ gas) and/or the oxygen gas (O₂ gas). In a typical example, one of both of the electrodes 112, 122 comprises a conductor substrate, such as a nickel substrate body, with an electrocatalyst coated onto one or more surfaces of the conductor substrate. In most cases, the electrocatalyst lowers the activation energy for the electrochemical reaction so that the reaction can proceed without the electrocatalyst being consumed by the reaction. By lowering the activation energy, an electrocatalyst is able to facilitate specific reactions at the electrode so that the electrochemical device has a reduced energy demand.

Examples of electrocatalyst materials include, but are not limited to, metals, metal alloys, metal-metalloid alloys, metal oxides, metal phosphides, and metal sulfides. Further details of some specific examples of electrocatalyst materials that can be applied to one or both electrodes 112, 122 are described in more detail below.

The ohmic resistance of the separator 131 can affect the voltage drop across the anode 112 and the cathode 122. For example, as the ohmic resistance of the separator 131 increases, the voltage across the anode 112 and the cathode 122 may increase, and vice versa. In an example, the separator 131 has a relatively low ohmic resistance and a relatively high ionic mobility. In an example, the separator 131 has a relatively high hydration characteristics that increase with temperature, and thus decreases the ohmic resistance. By selecting a separator 131 with lower ohmic resistance known in the art, the voltage drop across the anode 112 and the cathode 122 at a specified temperature can be lowered.

In an example, the anode 112 is electrically connected to an external positive conductor 116 (also referred to as “the anode conductor 116”) and the cathode 122 is electrically connected to an external negative conductor 126 (also referred to as “the cathode conductor 126”). In an example, when the separator 131 is wet and is in electrolytic contact with the electrodes 112 and 122, and an appropriate voltage is applied across the conductors 116 and 126, O₂ gas is liberated at the anode 112 and H₂ gas is liberated at the cathode 122. In certain configurations, an electrolyte, e.g., one comprising of a solution of potassium hydroxide (KOH) in water, is fed into the half cells 111, 121. For example, the electrolyte can flow into the anode half cell 111 through a first electrolyte inlet 114 and into the cathode half cell 121 through a second electrolyte inlet 124. In an example, the flow of the electrolyte through the anode half cell 111 picks up produced O₂ gas as bubbles 113 and exits the anode half cell 111 through a first outlet 115. Similarly, the flow of the electrolyte through the cathode half-cell 121 can pick up produced H₂ gas as bubbles 123 and can exit the cathode half cell 121 through a second outlet 125. The gases can be separated from the electrolyte downstream of the electrolyzer cell 100 with one or more appropriate separators. In an example, the produced H₂ gas is dried and harvested into high pressure canisters or fed into further process elements. The O₂ gas can be allowed to simply vent into the atmosphere or can be stored for other uses. In an example, the electrolyte is recycled back into the half cells 111, 121 as needed.

In an example, a typical voltage across the electrolyzer cell 100 (e.g., the voltage difference between the anode conductor 116 and the cathode conductor 126) is from about 1.5 volts (V) to about 3.0 V. In an example, an operating current density for the electrolyzer cell 100 is from about 0.1 A/cm² to about 3 A/cm². Each cell 100 has a size that is sufficiently large to produce a sizeable amount of H₂ gas when operating at these current densities. In an example, an active area of each cell 100 (e.g., a width multiplied by a height for a rectangular cell) is from about 0.25 square meters (m²) to about 15 m², such as from about 1 m² to about 5 m², for example from about 2 m² to about 4 m², such as from about 2.25 m² to about 3 m², such as from about 2.5 m² to about 2.9 m². In an example, the total volume of each cell (e.g., a width multiplied by a height multiplied by a depth) is from about 0.1 cubic meter (m³) to about 2 m³, such as from about 0.15 m³ to about 1.5 m³, for example from about 0.2 m³ to about 1 m³, such as from about 0.25 m³ to about 0.5 m³, for example from about 0.275 m³ to about 0.3 m³. In an example, the total volume of the entire electrolyzer system (e.g., the combined volume of all the cells in all the stacks in the plant) is from about 1 m³ to about 25,000 m³, such as from about 5 m3 to about 2,500 m³, for example from about 10 m³ to about 100 m³, such as from about 25 m³ to about 75 m³, for example from about 30 m³ to about 50 m³.

The efficiency of an electrolyzer cell can depend on resistive losses between the anode and cathode. One parameter that can affect the ohmic resistance between the electrodes is the distance between the anode and the cathode, with a larger gap between the electrodes resulting in a correspondingly larger resistance compared to a smaller gap. Therefore, in an example, an electrolyzer cell can be configured so that the space or gap between the anode and the cathode is as small as possible. In one example configuration, one or both of the anode and the cathode are positioned so that the electrode is in contact with the separator, which is also referred to as a “zero-gap” configuration. In an example of a zero gap configuration, one face or surface of the anode is in contact with a first surface of the separator and one face or surface of the cathode is in contact with an opposing second surface of the separator.

Typically, one or both of the electrodes are coated with one or more catalyst compositions. Specific examples of catalyst compositions that can be coated onto one or both of the anode and the cathode are described below.

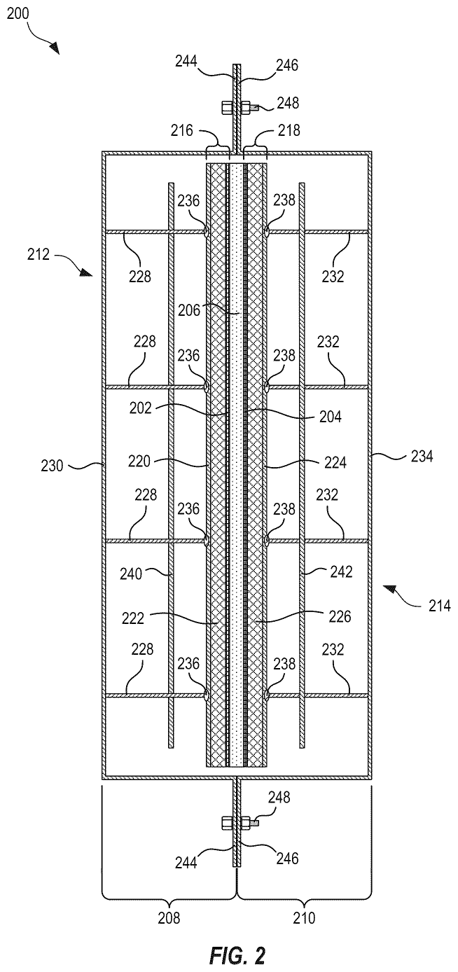

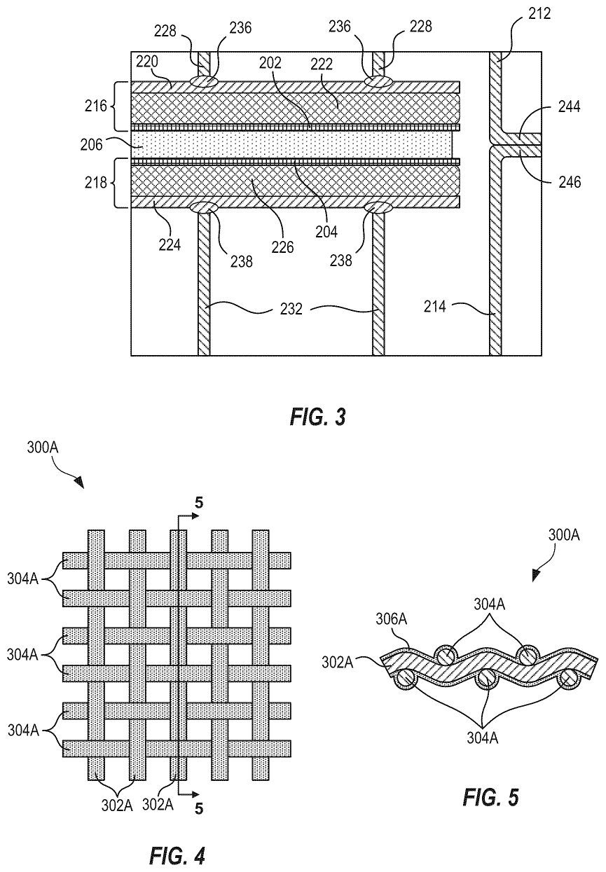

FIGS. 2 and 3 show an example of a pan assembly 200 that can provide for a zero gap architecture for an electrolyzer cell, e.g., with one or both electrodes compressed against a separator. FIG. 2 shows an overall cross-sectional view of the example pan assembly 200, while FIG. 3 shows a close-up cross-sectional view of the portion of the pan assembly 200 including the electrodes and the separator. In an example, the pan assembly 200 shown in FIGS. 2 and 3 can form the electrolyzer cell 100 of FIG. 1.

In the example shown in FIGS. 2, and 3, the pan assembly 200 includes a housing that at least partially encloses a cell interior, wherein a first electrode 202 and a second electrode 204, and in some examples a separator 206 are enclosed within the cell interior. In an example, each electrode 202, 204 can be part of a corresponding half cell. For example, the first electrode 202 can be included as part of a first half cell and the second electrode 204 can be included as part of a second half cell. In a non-limiting example, the first electrode 202 is the anode of the pan assembly 200 and the second electrode 204 is the cathode of the pan assembly 200, such that the electrodes 202, 204 will also be referred to as the anode 202 and the cathode 204, and the corresponding half cells will also be referred to as the anode half cell (i.e., the half-cell associated with the anode 202) and the cathode half cell (i.e., the half-cell associated with the cathode 204). There are also instances when the anode 202 and the cathode 204 are referred to more generically as “the electrode 202, 204” or “the electrodes 202, 204.”

The separator 206 can be situated between the anode half cell and the cathode half cell, for example by being positioned between the anode 202 and the cathode 204. As discussed above, the separator 206 can be configured to reduce migration of certain species between the electrodes 202, 204 while allowing one or more other species to pass from the anode half cell to the cathode half cell and/or from the cathode half cell to the anode half cell. In an example, the separator 206 comprises a diaphragm, a membrane electrode assembly (MEA), or a membrane, such as an ion exchange membrane (IEM) (e.g., an anion exchange membrane (AEM), a cation exchange membrane (CEM), or a proton exchange membrane (PEM)), a bipolar ion exchange membrane (BEM), an ion solvating membrane (ISM), or a microporous or nanoporous membrane. In some examples, the separator 206 can comprise more than one type of separator, e.g., more than one type of membrane (as is the case with a bipolar ion exchange membrane), and/or can be part of a composite structure (such as a membrane electrode assembly (MEA)), which can also include one or more separator components (e.g., to separate an anion exchange membrane (AEM) from a cation exchange membrane (CEM)), or one or more support structures to provide mechanical integrity to the one or more separators. In addition to these components, individual gaskets or gasket tape may be provided in between and along the outer perimeter of the components to seal the compartments from fluid leakage.

As discussed above, in an example, each of the electrodes 202, 204 is situated in a “zero-gap” configuration relative to the separator 206. Although the term “zero-gap” would typically imply that one or both electrodes 202, 204 are in actual physical contact with the separator 206, in the present disclosure, the term “zero-gap” is expanded to mean that all structures between the two current collectors 220, 224 (described below) are in mechanical contact with no space for the liquid electrolyte to congregate. In other words, there could be one or more spacer materials inserted between one or both of the current collectors 220, 224 and the separator 206, and the overall structure would still be considered a “zero-gap architecture,” as that term is being used herein, so long as there is not a liquid electrolyte gap between the two current collectors 220, 224.

The housing of the cell 200 can comprise a pan assembly 208, 210 for one or both of the half cells, such as an anode-side pan assembly 208 for the anode half cell and a cathode-side pan assembly 210 for the cathode half cell (also referred to as the anode pan assembly 208 and the cathode pan assembly 210). In an example, each pan assembly 208, 210 includes a pan 212, 214 with an interior for receiving an electrolyte. For example, the anode pan assembly 208 can comprise an anode-side pan 212 for receiving an anolyte and the cathode pan assembly 210 comprising a cathode-side pan 214 for receiving a catholyte. The pan assemblies 208, 210 can be configured so that the electrolyte flowing through the pan 212, 214 will come into contact with its corresponding electrode 202, 204, e.g., so that H₂ gas can be evolved from the cathode 204 and, in some examples, so that O₂ gas can be evolved from the anode 202. Each pan assembly 208, 210 can also include an inlet for receiving electrolyte into the interior of the pan 212, 214, and one or more outlets so that electrolyte and evolved gas can exit the pan 212, 214 (not shown).

In an example, each electrode 202, 204 is electrically connected to its corresponding pan 212, 214 so that electrical current can flow from the pan 212, 214 to the electrode 202, 204 (as is the case for current flowing from an anode-side pan 212 to an anode 202) or from the electrode 202, 204 to the pan 212, 214 (as is the case for current flowing from a cathode 204 to a cathode-side pan 214). Each half cell can include one or more additional structures to provide for the electrical connection between the electrodes 202, 204 and the pans 212, 214. For example, one or both of the electrodes 202, 204 can be part of a corresponding electrode assembly comprising the electrode 202, 204 and one or more additional structures that enhance operation of the pan assembly 200. For example, the first electrode 202 (e.g., the anode 202) can be part of a first electrode assembly 216 (which will also be referred to herein as “the anode assembly 216”) and the second electrode 204 (e.g., the cathode 204) can be part of a second electrode assembly 218 (which will also be referred to herein as “the cathode assembly 218”).

In an example, one or both of the electrode assemblies 216, 218 include its corresponding electrode 202, 204, a current collector, and an optional elastic element (also sometimes referred to as a “mattress”). In an example, the anode assembly 216 includes the anode 202, an anode current collector 220 and an optional anode-side elastic element 222. Similarly, in an example, the cathode assembly 218 includes the cathode 204, a cathode current collector 224, and an optional cathode-side elastic element 226.

Each electrode assembly 216, 218 is coupled to its respective pan 212, 214, i.e., so that there is an electrical connection between the anode 202 and the anode-side pan 212 and between the cathode 204 and the cathode-side pan 214. In an example, one or both of the electrodes 202, 204 comprise a fine mesh structure, such as a fine woven mesh. A fine mesh, such as a woven mesh, have been found to make an excellent electrode for electrolyzer cells because it provides a high relative surface area, a relatively large open area for electrolyte and gas flow to and from the electrode, and are readily available in sizes that are large enough for a large commercial electrolyzer cell, e.g., with an active area of at least 1 m², such as from about 1 m² to about 4 m².

In an example, a differential fluid pressure can be applied across the separator 206 (e.g., with a pressure on the cathode side of the separator 206 being larger than on the anode side, or vice versa). The differential pressure, in addition to the elastic element 222, 226 can act to load the electrodes 202, 204 and create effective electrical contact across the active area of the electrodes 202, 204 without requiring welding to couple the electrodes 202, 204 to other structures in the pan assembly 200, particularly with fine mesh electrodes.

In an example, the woven mesh of one or both of the electrodes 202, 204 comprises a network of sets of crossing wires, which can be perpendicular or angled relative to one another, that alternative cross and bend over one another. For example, any particular wire alternates between passing under an adjacent cross wire and then over the next cross wire. In an example, one or both of the electrodes 202, 204 can comprise a woven wire mesh electrode formed from wires having a wire diameter of about 0.18 mm diameter with openings in the mesh of about 0.44 mm and with an open area of from about 50% to about 60%, such as from about 50% to about 55%. In an example, one or both of the electrodes 202, 204 is formed from an expanded mesh wherein one or both of the electrodes 202, 204 are fabricated from a sheet of material that is about 0.13 mm thick with a long way of the diamond shape (LWD) of about 2 mm and a short way of the diamond (SWD) of about 1 mm.

Several non-limiting example configurations of woven meshes are shown in FIGS. 4-9. FIGS. 4 and 5 show a plan view and a cross-sectional view, respectively, of an example woven mesh electrode 300A formed by a plain/double weave of warp wires 302A and shute wires 304A. In the example shown, the weave results in substantially rectangular openings with wire sizes that may be the same in both directions. As shown, each warp wire 302A passes alternatively over and under the shute wires 304A at right angles and, similarly, each shute wire 304A passes alternatively over and under the warp wires 302A.

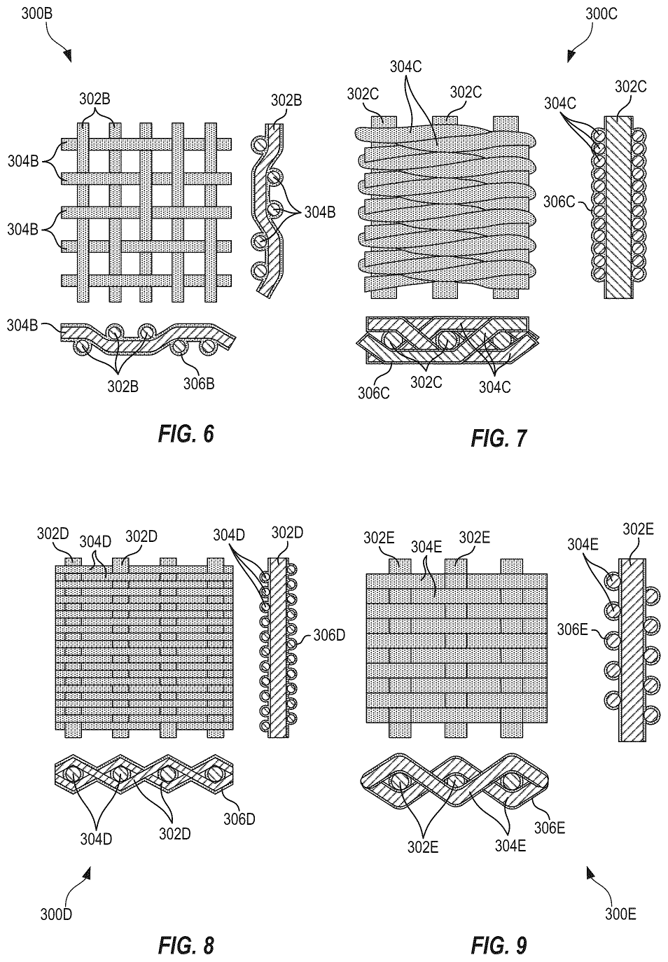

FIG. 6 shows top and cross-sectional views of an example woven mesh electrode 300B comprising a twill square weave of warp wires 302B and shute wires 304B. In this type of weave, each warp wire 302B is woven alternatively over two consecutive shute wires 304B and then under two consecutive shute wires 304B. Similarly, each shute wire 304B is woven alternatively over two consecutive warp wires 302B and then under two consecutive warp wires 302B. As can be seen in FIG. 6, the twill square weave gives the appearance of two parallel diagonal lines, which allows it to be used under greater loads.

FIG. 7 shows top and cross-sectional views of an example woven mesh electrode 300C comprising a twill Dutch weave of warp wires 302C and shute wires 304C. In this weave, each shute wire 304C passes over two warp wires 302C and under two warp wires 302C. Pairs of adjacent shute wires 304C can also wrap around each other. This weave offers higher strength than a plain Dutch weave (FIG. 9) because it has higher wire density for a given area.

FIG. 8 shows top and cross-sectional views of an example woven mesh electrode 300D comprising a reverse plain Dutch weave of warp wires 302D and shute wires 204D. In this type of weave, a larger number of wires 304D can be in the shute direction and a smaller number of wires 302D can be in the warp direction. In an example, the shute wires 304D can have a smaller diameter than the warp wires 302D, and in an example the shute wires 304D can touch each other. In an example, the heavier warp wires 302D are woven as tightly together as possible.

FIG. 9 shows top and cross-sectional views of an example woven mesh electrode 300E comprising a plain Dutch weave of warp wires 302E and shute wires 304E, which results in openings that are slanted diagonally. This weave has a coarser (thicker) wire in the shute direction compared to, for example, the reverse plain Dutch weave of the mesh electrode 300D of FIG. 8.

In an example, one or both of the anode 202 and the cathode 204 is made primarily or entirely from nickel. Fabricating both the anode 202 and the cathode 204 out of nickel enables the use of non-welded electrodes fabricated from fine woven meshes for both electrodes 202, 204, for example because nickel has a very low contact resistance. In an example, one or both of the anode 202 and the cathode 204 is coated with one or more catalyst materials, e.g., in the form of one or more catalyst coating layers on the electrode 202, 204. In an example, the one or more catalyst materials can be electrically conducting.

The current collector 220, 224 of each electrode assembly 216, 218 acts to distribute current flowing into or out of its respective electrode 202, 204. In an example, the current collector 220, 224 of each electrode assembly 216, 218 comprises a rigid structure, such as a rigid metal plate or mesh, which is electrically connected to its corresponding electrode 202, 204, either directly or indirectly. In an example, each current collector 220, 224 can comprises an expanded metal sheet, such as an expanded nickel sheet.

In an example, each elastic element 222, 226 comprises a compressible and expandable structure that provides a controlled load when compressed. For example, the elastic element 222, 226 can be compressed between the separator 206 and the current collector 220, 224, and the resulting load that results as the elastic element 222, 226 tries to expand back to its fully expanded position acts to load the electrode 202, 204 against the separator 206 to provide a zero-gap configuration between the electrode 202, 204 and the separator 206. In an example, the elastic element 222, 226 is also electrically conductive (e.g., the elastic element 222, 226 is made from or is coated with an electrically conductive material, such as nickel) so that it will conduct electricity from the current collector 220, 224 to the electrode 202, 204 or vice versa. In an example, each of the one or more elastic elements 222, 226 comprise one or more electrically conductive filaments that are woven together into an elastic layer that can expand and collapse to apply the controlled load when the elastic layer is compressed. In some examples, one or both of the elastic elements 222, 226 can be a corrugated knitted mesh having a pre-load of about 2 pounds per square inch at about 3 mm of compression. In an example, an uncompressed thickness of one or both of the elastic elements 222, 226 can be from about 5 mm to about 7 mm. One or both of the elastic elements 222, 226 can have a corrugation pitch of about 10 mm. In an example, one or both of the elastic elements 222, 226 are formed from wire having a wire diameter of about 0.15 mm.

In the example shown in FIGS. 2 and 3 both the anode assembly 216 and the cathode assembly 218 include an elastic element 222, 226, e.g., such that the anode-side elastic element 222 provides a first loading force to compress the anode 202 against one side of the separator 206 and the cathode-side elastic element 226 provides a second loading force to compress the cathode 204 against an opposing side of the separator 206. In other examples (not shown in the Figures), there is an elastic element on only one side of the separator 206 (e.g., with only the anode assembly 216 having the elastic element 228 and with the cathode assembly 218 omitting the elastic element 232, or vice versa with only the cathode assembly 218 having the elastic element 232 and with the anode assembly 216 omitting the elastic element 228). In such a configuration, the elastic element on only one side of the separator 206 can produce sufficient compressive load so that both electrodes 202, 204 are compressed against the opposing sides of the separator 206.

In an example, the current collectors 220, 224 can be coupled to their respective pans 212, 214, e.g., so that the current collector 220, 224 is electrically connected to its corresponding pan 212, 214, which provides part of the electrical path between the electrode 202, 204 and the pan 212, 214. In order to accommodate this electrical connection between the current collector 220, 224 and its corresponding pan 212, 214, in an example, each pan assembly 208, 210 includes one or more ribs that extend between the electrode assembly 216, 218 and a back wall of the pan. For example, the anode pan assembly 208 can include one or more ribs 228 that extend between a back wall 230 of the anode-side pan 212 and the anode assembly 216, while the cathode pan assembly 210 can include one or more ribs 232 that extend between a back wall 234 of the cathode-side pan 214 and the cathode assembly 218. The one or more ribs 228 can be welded to the back wall 230 of the anode-side pan 212 while the one or more ribs 232 can be welded to the back wall 234 of the cathode-side pan 214.

The one or more ribs 228, 232 of each pan assembly 208, 210 can be electrically coupled to its corresponding electrode assembly 216, 218 by one or more welds, e.g., one or more welds 236 that electrically couple the anode assembly 216 to the one or more ribs 228 of the anode pan assembly 208 and one or more welds 238 that electrically couple the cathode assembly 218 to the one or more ribs 232 of the cathode pan assembly 210. As shown in FIG. 2, in an example, the one or more welds 236 can electrically couple the one or more ribs 228 to the anode current collector 220 and the one or more welds 238 can electrically couple the one or more ribs 232 to the cathode current collector 224.

In an example, the electrodes 202, 204 can be electrically connected to the one or more ribs 228, 232 and the one or more welds 236, 238. In examples where the electrode assembly 216, 218 includes the current collector 220, 224 that is welded to the one or more ribs 228, 232, then the electrode 202, 204 of the electrode assembly 216, 218 can be electrically coupled to the current collector 220, 224 via physical contact between the electrode 202, 204 and the current collector 220, 224, e.g., such as by wrapping the flexible electrode 202, 204 around a back side of the current collector 220, 224 so that there is physical contact between the mesh electrode 202, 204 and the current collector 220, 224, and/or through the elastic element 222, 226, which can also be made from a conductive material, such as metal. In an example, each of the mesh electrode 202, 204, the current collector 220, 224, and the elastic element 222, 226 of each electrode assembly 216, 218 can be made from nickel. When the loading pressure across an interface is sufficiently high (e.g., the loading pressure provided by one or both of the elastic element 222, 226 and a differential pressure across the cell), the contact resistance of a contact point between a nickel surface another electrically conductive material is very low, such that when a nickel electrode 202, 204 is in contact with a nickel elastic element 222, 226 or a nickel current collector 220, 224, electricity will readily flow through the contact point between the two nickel structures. This can allow the electrodes 202, 204 to be coupled to the electrode assembly 216, 218 without requiring welding between the electrodes 202, 204 and another structure while still providing for low resistance between the electrodes 202, 204 and the rest of the pan assembly 200. Such a non-welded electrode assembly structure is described in in U.S. patent application Ser. No. 18/163,010, filed on Feb. 1, 2023, entitled “ELECTROLYZER CELL AND METHODS OF USING AND MANUFACTURING THE SAME,” the disclosure of which is incorporated herein by reference in its entirety.

The electrodes 202, 204 can be electrically coupled to the supplied electrical current via the one or more ribs 228, 232 and the one or more welds 236, 238. During operation of the pan assembly 200, current flows from a conductor contacting the anode-side pan 212 (similar to the anode conductor 116 in the electrolyzer cell 100 of FIG. 1), where the current can then flow to the one or more ribs 228 of the anode pan assembly 208 (e.g., through welds between the ribs 228 and the back wall 230), then to the anode current collector 220 via the one or more welds 236, and then into the anode 202 (e.g., via the contact between the anode current collector 220 and the anode 202 or via the electrically-conducting anode-side elastic element 222). The current can then pass between the anode 202 and the cathode 204 via the separator 206. The current then flows from the cathode 204 to the cathode current collector 224 (e.g., via the contact between the cathode 204 and the cathode current collector 224 or via the electrically conducting cathode-side elastic element 226), where it can then flow from the cathode current collector 224 to the one or more ribs 232 via the one or more welds 238. Then, the current can flow from the one or more ribs 232 to the cathode-side pan 214 (such as via welds between the one or more ribs 232 and the back wall 234 of the cathode-side pan 214), and finally out of the pan assembly 200 via a conductor that is contacting the cathode-side pan 214 (similar to the cathode conductor 126 in the electrolyzer cell 100 of FIG. 1).

The geometry and spacing of the one or more ribs 228, 232 can dictate current flow through the pan assemblies 208, 210. The geometry of the ribs 228, 232 can include, but is not limited to, the number of the ribs 228, 232, the height of the ribs 228, 232 (e.g., the distance between the back wall 230, 234 and the electrode assembly 216, 218 to which the ribs 228, 232 are connected), the physical design of the ribs 228, 232, the pitch between adjacent ribs 228, 232, and/or the thickness of the ribs 228, 232. As the current flows in through the ribs 228, 232 and the welds 236, 238, the geometry, spacing or density, and/or cross-sectional area of the welds 236, 238 can also impact current flow through the pan assemblies 208, 210. For example, as increasingly high currents flow through the cell, the density and the cross sectional area of the welds 236, 238 can impact local Joule heating and the formation of local hot spots, which can cause damage to the separator 206. In an example, the geometry, spacing, and cross-sectional area of the ribs 228, 232 and/or the welds 236, 238 can facilitate efficient operation of the pan assembly 200 at high current densities.

Further details regarding geometries and other configurations of the one or more ribs 228, 232 and the one or more welds 236, 238 for coupling the one or more ribs 228, 232 to the electrode assemblies 216, 218 (e.g., to the current collectors 220, 224) are described in U.S. Pat. No. 11,390,956, issued on Jul. 19, 2022, entitled “ANODE AND/OR CATHODE PAN ASSEMBLIES IN AN ELECTROCHEMICAL CELL, AND METHODS OF USE AND MANUFACTURE THEREOF,” the disclosure of which is incorporated herein by reference in its entirety.

In an example, one or both of the pan assemblies 208, 210 includes a baffle plate that is fitted within its corresponding pan 212, 214 that is generally aligned with the orientation of the pan 212, 214 and the electrode assembly 216, 218 of that particular pan assembly 208, 210. For example, the anode pan assembly 208 can include an anode-side baffle plate 240 located within the interior of the anode-side pan 212 and the cathode pan assembly 210 can include a cathode-side baffle plate 242 located within the interior of the cathode-side pan 214. Each baffle plate 240, 242 is coupled to its corresponding set of one or more ribs 228, 232 to position the baffle plate 240, 242 within its corresponding pan 212, 214, e.g., at a specified position relative to its corresponding electrode assembly 216, 218 and/or its corresponding back wall 230, 234.

In an example, one or both of the baffle plates 240, 242 comprise a solid plate that is configured to fit over or within the one or more ribs 228, 232 of its corresponding pan assembly 208, 210. In other examples, one or both of the baffle plates 240, 242 can comprise an expanded metal plate or a mesh. In an example, one or both of the baffle plates 240, 242 are made from a conductive metal, such as, but not limited to, nickel, stainless steel, and the like. In another example, one or both of the baffle plates 240, 242 are made from a polymeric material.

As will be appreciated by those having skill in the art, the contribution of internal power dissipation to the internal temperature distribution within the pan assembly 200 can be reduced or minimized through operating conditions such as the temperature and flow rate of the electrolyte flowing through the pan assembly 200 (e.g., through the pan assemblies 208, 210). High electrolyte flow rates can increase and in some examples maximize convective heat transfer within the pan assembly 200, thereby helping to reduce or minimize heat buildup and the corresponding concomitant temperature rise within the cell 200 that could otherwise result from high current densities. The baffle plates 240, 242 can provide for mixing of electrolyte as it flows through the pan assemblies 208, 210 to enhance convective heat transfer within the electrolyte during electrolysis.

In some examples, the baffle plate 240, 242 is designed and positioned in its corresponding pan 212, 214 in such a way that the gas produced at the electrode assembly 216, 218 can mix with the electrolyte on the side of the baffle plate 240, 242 closest to the electrode assembly 216, 218, resulting in a relatively low density column and defining a riser section. The low density mixture can rise relatively quickly through the riser section. Once above the top of the baffle plate 240, 242, the gas can disengage and flow into an outlet (such as a manifold, not shown in FIG. 2). A fraction of the electrolyte may then drop back down the side of the baffle plate 240, 242 closer to the back wall 230, 234 of the pan 212, 214 (i.e., the side opposite to the electrode assembly 216, 218) into a down-corner region, thereby creating a circulation loop.

The gas evolved at the electrode 202, 204 impacts the flow of the electrolyte, dragging some of the electrolyte up, and buffeting some of the electrolyte laterally. Gas lift occurs along the region adjacent to the electrode assembly 216, 218. The presence of the baffle plate 240, 242 can create a strong circulation within the pan assembly 208, 210. The flow of electrolyte in the riser section on the side of the baffle plate 240, 242 closest to the electrode assembly 216, 218 can be strongly oriented upward due to gas lift, and the flow in the down-corner section on the side of the baffle plate 240, 242 closest to the back wall 230, 234 can be strongly oriented downward. The relatively high velocities and shear rates in the riser section can help sweep gas from the electrode assembly 216, 218, provide efficient top to bottom mixing within the pan 212, 214, and drive increased convective cooling.

The baffle plate 240, 242 can be used to create a rapidly flowing circulation loop so that the electrolyte remains substantially isothermal as it flows through the pan assemblies 208, 210. Due to the high degree of top-bottom mixing and circulation, rapid thermal equilibration of the electrolyte can be achieved as it flows into and through the pan assemblies 208, 210. Another advantage is that relatively cold electrolyte can be introduced into the pan assembly 208, 210 which can equilibrate with warm circulating electrolyte fluid relatively quickly. The circulation rate (or laps of the recirculation loop during electrolyte transit through the pan 212, 214) can be anywhere from 1 to 200. The high circulation rate can also drive larger shear rates adjacent to the separator 206, helping to sweep gas away from the separator 206 and/or enhance or maximize heat transfer from the separator 206 to the electrode 202, 204.

Further details regarding a baffle plate in the pan assemblies 208, 210 are described in U.S. Pat. No. 11,444,304, issued on Sep. 13, 2022, entitled “ANODE AND/OR CATHODE PAN ASSEMBLIES IN AN ELECTROCHEMICAL CELL, AND METHODS TO USE AND MANUFACTURE THEREOF,” the disclosure of which is incorporated herein by reference in its entirety.

The pan assemblies 208, 210 can be coupled together to enclose the interior of the pan assembly 200. For example, a flange 244 of the anode-side pan 212 can be coupled to a corresponding flange 246 of the cathode-side pan 214, such as with one or more fasteners 248. In the example shown in FIG. 2, the one or more fasteners 248 include one or more bolts and corresponding nuts that can be used to securely affix the flanges 244 and 246 together to enclose the interior of the pans 212, 214 and form the overall pan assembly 200.

### Catalyst Coating

As mentioned above, one or both of the electrodes 112, 122 of the cell 100 of FIG. 1, such as one or both of the electrodes 202, 204 of the pan assembly 200 of FIGS. 2 and 3, can be at least partially coated by a catalyst material coating. For example, the woven mesh electrodes 300A-E of FIGS. 4-9 each include a catalyst coating 306A, 306B, 306C, 306D, and 306E.

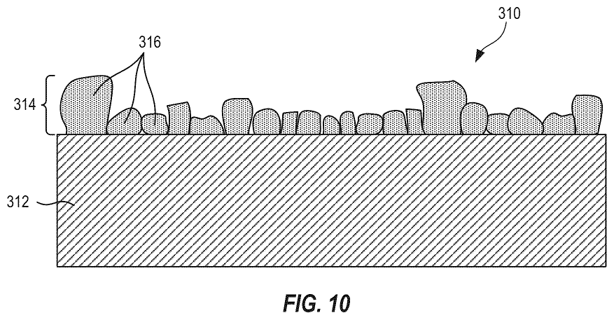

FIG. 10 shows a close-up conceptual view of an example electrode 310 comprising a conductive substrate 312, e.g., a wire 302, 304 of one of the woven meshes 300 described above with respect to FIGS. 4-9, wherein a surface of the conductive substrate 312 has been coated with an electrocatalyst coating 314. In the example shown in FIG. 10, the electrocatalyst coating 314 comprises a plurality of spinel particles 316 each comprising one or more electrocatalyst materials. In preferred examples, the spinel particles 316 are nanosized particles, e.g., having a largest particle size that is less than or equal to about 900 nanometers (nm), for example less than or equal to about 750 nm, such as less than or equal to about 500 nm, for example less than or equal to about 450 nm, such as less than or equal to about 400 nm, for example less than or equal to about 350 nm, such as less than or equal to about 325 nm, for example less than or equal to about 300 nm, such as less than or equal to about 275 nm, for example less than or equal to about 250 nm, such as less than or equal to about 250 nm, for example less than or equal to about 225 nm, such as less than or equal to about 200 nm. The method 350 described below for the making of a catalyst coated substrate is able to achieve nanosized spinel particles 316 that are adhered directly to the surfaces of the conductive substrate (e.g., without requiring a binder to adhere the particles 316 to the substrate 312), without requiring very high temperatures (e.g., higher than 400° C.), and a pressure above atmospheric pressure, without requiring an inert atmosphere (e.g., with a high concentration of nitrogen gas or another inert gas), and without requiring templating or other specialized methods of patterning the coating onto the substrate 312.

The effectiveness of an electrocatalyst is often evaluated based on its activity, stability, and selectivity. Each of these parameters often depend on various properties of the electrocatalyst material, including surface area, binding energy, electrical conductivity, electrocatalytic activity, mechanical stability, chemical stability, cost, and structure (such as crystal structure). The synthesis method used to produce an electrocatalyst material often dictates what chemical structure (e.g., crystal structure) can be produced. Therefore, the effectiveness of an electrocatalyst can be modified by altering the preparation method and/or chemical composition of the electrocatalyst.

Many methods have been used for the synthesis of electrocatalysts, either as a product itself or as a coating on an electrode to be used for an electro-reaction. Examples of such synthesis methods include: (i) chemical synthesis (including, but not limited to, coprecipitation, sol-gel synthesis, colloidal synthesis, impregnation, and microemulsion synthesis); (ii) electrochemical deposition (such as electrodeposition, underpotential deposition, and overpotential deposition); (iii) thermal synthesis (such as hydro and/or solvo thermal reaction, thermal decomposition, or spray pyrolysis); (iv) vapor deposition (such as chemical vapor deposition or physical vapor deposition); and (v) solid-state techniques (such as high-energy ball milling).

In practice, the synthesis of electrocatalyst materials often involve a combination of two or more of these methods, which can make the process more difficult and can require a larger number of specialized equipment, which increases the capital cost to implement the chosen synthesis method. A combination of two or more of the methods can also result in a lower overall capacity when compared to similar synthesis processes that only require one method type and less equipment.

In an example, the electrocatalyst particles 316 in the electrocatalyst coating 314 comprise a spinel crystal structure (AB₂O₄). Spinel materials have been shown to provide for enhanced performance over other crystal structures for various electro-reactions, and in particular for oxidation reactions (such as the oxidation reaction to produce oxygen gas at the anode of a water electrolysis cell). Because oxidation reactions are often a bottleneck for green technologies, the scalable synthesis of electrocatalysts comprising spinel crystal structures can provide for more economical and efficient green technologies, including water electrolysis.

The present disclosure describes methods of producing an electrode for use in an electrochemical reaction, such as water electrolysis, comprising an electrocatalyst material that has a spinel structure, and in particular nanostructured spinel-based material that can be a catalyst for electrochemical reactions, such an oxidation reaction and/or a reduction reaction in an electrolysis process. The present disclosure also describes the electrodes that result from these methods. In some examples, the method comprises synthesizing a spinel catalyst material directly on the conductive substrate of the electrode.

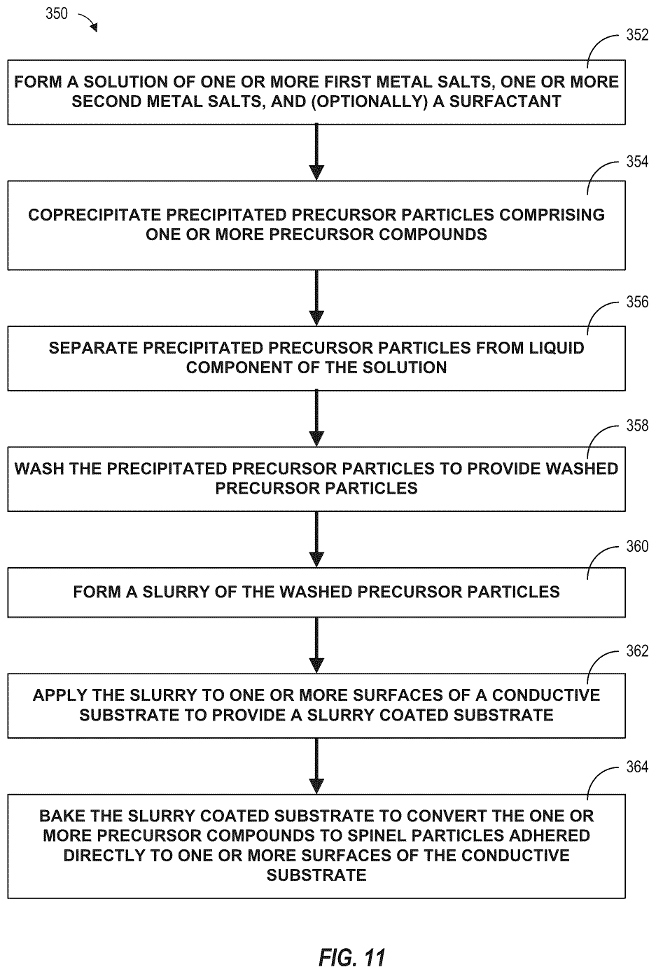

FIG. 11 shows a flow diagram of an example method 350 for preparing an electrocatalyst coated electrode, such as the example electrode 310 with the electrocatalyst coating 314 shown in FIG. 10. The example method 350 includes, at step 352, forming a salt solution of one or more first metal salts, one or more second metal salts, and (optionally) a surfactant.

In an example, each of the one or more first metal salts in the salt solution comprise one or more first salts of one or more first metal elements and each of the one or more second metal salts in the salt solution comprise one or more second salts of one or more second metal elements. In an example, the one or more first salts and the one or more second salts each comprise one or more of: a metal nitrate, a metal acetate, a metal sulfate, and a metal halide (e.g., a metal chloride or a metal bromide).

In an example, each of the one or more first salts of the one or more first metal elements are a different type of salt from each of the one or more second salts of the one or more second metal elements. For example, if the first salts comprise nitrates of the one or more first metal elements, then in an example the one or more second salts are not nitrates of the one or more second metal elements (i.e., the one or more second salts could be halides of the one or more second metal elements, and/or acetates of the one or more second metal elements, and/or sulfates of the one or more second metal elements, but not nitrates of the one or more second metal elements). In another example, if the first salts comprise nitrates and acetates of the one or more first metal elements, than the second salts can include halides and/or sulfates of the one or more second metal elements, but not nitrates or acetates of the one or more second metal elements.

The one or more first metal elements and the one or more second metal elements, e.g., that form the one or more first salts and the one or more second salts in the salt solution of step 352, can be any metal element that will be able to form either the one or more “A” metal ions or the one or more “B” metal ion in a spinel structure, that is a crystal structure having the general formula AB₂O₄ wherein the one or more “A” metal ions occupy octahedral sites and the one or more “B” metal ions are distributed over both octahedral sites and tetrahedral sites, as would be understood by a person having ordinary skill in the art. In an example, the one or more first salts of the one or more first metal elements that are included in the salt solution include all of the one or more “A” metal elements of the final spinel formula (AB₂O₄) and the one or more second salts of the one or more second metal elements that are included in the salt solution include all of the one or more “B” metal elements of the final spinel formula. In another example, the first and second salts are reversed, i.e., with the one or more first salts of the one or more first metal elements including all of the one or more “B” metal elements of the final spinel formula, and the one or more second salts of the one or more second metal elements including all of the one or more “A” metal elements of the final spinel formula.

In an example, the “A” metal ion of the spinel formula can include, but is not limited to: nickel (Ni), zinc (Zn), copper (Cu), cobalt (Co), iron (Fe), lithium (Li), magnesium (Mg), calcium (Ca), barium (Ba), manganese (Mn), germanium (Ge), cadmium (Cd), lanthanide (La), Yttrium (Y), chromium (Cr), molybdenum (Mo), ruthenium (Ru), and iridium (Ir).

In an example, the “B” metal ion of the spinel formula can include, but is not limited to: cobalt (Co), iron (Fe), chromium (Cr), aluminum (Al), manganese (Mn), nickel (Ni), gallium (Ga), selenium (Se), molybdenum (Mo), ruthenium (Ru), sulfur (S), and tellurium (Te).

As described above, the coated electrode 300 can be used as an electrode for water splitting electrolysis, such as one or both of the electrodes 112, 122 in the cell 100 of FIG. 1 or the electrodes 202, 204 in the pan assembly 200 of FIG. 2. Examples of spinel electrocatalyst materials that can form the electrocatalyst particles 316 in such an electrode 300 include, but are not limited to, a cobalt-based spinel (sometimes also referred to as a cobaltite) having the general formula MCo₂O₄, an iron-based spinel (sometimes also referred to as a ferrite) having the general formula MFe₂O₄, a manganese-based spinel (sometimes also referred to as a manganite) having the general formula MMn₂O₄. For each of these spinel compound formulas, M is a metal ion such as, but not limited to one or more of: nickel (N), zinc (Zn), copper (Cu), cobalt (Co), iron (Fe), lithium (Li), magnesium (Mg), calcium (Ca), barium (Ba), manganese (Mn), germanium (Ge), cadmium (Cd), and lanthanide (La). Specific examples of cobalt-based spinels that can be used as an electrolysis catalyst include, but are not limited to, nickel cobaltite (NiCo₂O₄), cobalt (II,III) oxide (Co₃O₄), manganese cobaltite (MnCo₂O₄), copper cobaltite (CuₓCo₃₋ₓO₄, such as CuCo₂O₄), zinc cobaltite (ZnCo₂O₄), lithium cobaltite (LiCoO₂ or LiCo₂O₄). Specific examples of iron-based spinels that can be used as an electrolysis catalyst include, but are not limited to, iron (II,III) oxide (Fe₃O₄), cobalt ferrite (CoFe₂O₄), nickel ferrite (NiFe₂O₄), manganese ferrite (MnFe₂O₄), and zinc ferrite (ZnFe₂O₄). Specific examples of manganese-based spinels that can be used as an electrolysis catalyst include, but are not limited to, manganese (II,III) oxide (Mn₃O₄), cobalt manganite (CoMn₂O₄), and lithium manganite (LiMn₂O₄).

The surfactant that can optionally be included in the solution of step 352 can be any surfactant that can act as a template for the formation of precursor particles during coprecipitation (step 354, discussed below) such that the co-precipitated precursor particles will have a specified size. In an example, the specified size provided for by the surfactant (if present) is about 1 micrometer (μm) or less, for example about 975 nanometers (nm) or less, such about 950 nm or less, about 925 nm or less, about 900 nm or less, about 875 nm or less, about 850 nm or less, about 825 nm or less, about 800 nm or less, about 750 nm or less, about 725 nm or less, about 700 nm or less, about 675 nm or less, about 650 nm or less, about 625 nm or less, about 600 nm or less, about 575 nm or less, about 550 nm or less, about 525 nm or less, about 500 nm or less, about 475 nm or less, about 450 nm or less, about 425 nm or less, about 400 nm or less, about 375 nm or less, about 350 nm or less, about 325 nm or less, or about 300 nm or less. Examples of surfactants that can be used for the process of the present disclosure include, but are not limited to, polyethylene glycol (PEG), polyethylene glycol dodecyl ether (such as the surfactant sold under the trade name BRIJ L4 by Sigma-Aldrich, Inc., St. Louis, MO USA), and oleic acid.

In an example, forming the solution (step 352) comprises dissolving the one or more first metal salts and the one or more second metal salts in a solvent, such as water. In examples that include a surfactant, the one or more first metal salts and the one or more second metal salts can be dissolved in the solvent, and then the surfactant can be added to the resulting solution, or the surfactant can first be added to the solvent and then the one or more first metal salts and the one or more second metal salts can be dissolved in the solvent and surfactant mixture, or the surfactant and the one or more first and second metal salts can be added to the solvent at the same time or substantially the same time.

In an example, the relative amount of each of the one or more first metal salts and the one or more second metal salts that are dissolved in the solution correspond to the stoichiometric amount of each metal ion in the final spinel material that is to be formed. For example, if the specified final spinel is nickel cobaltite (NiCo₂O₄), then the concentration of the nickel-containing salt (e.g., nickel nitrate (Ni(NO₃)₂) in the solution can be about one half the concentration of the cobalt-containing salt (e.g., cobalt chloride (CoCl₂)). In some examples, there are more than one “A” metal ion or more than one “B” metal ion in the desired spinel, and the corresponding concentrations of each salt will be selected accordingly. For example, if the final desired spinel is a ferrite (e.g., with the “B” metal ion being Fe) with “A” metal ions comprising nickel and zinc with a relative chemical formula of Ni_{0.4}Zn_{0.6}Fe₂O₄, the ratio of the concentrations of the nickel containing salt (e.g., Ni(NO₃)₂), the zinc-containing salt (e.g., Zn(NO₃)₂), and the iron-containing salt (e.g., FeCl₂) can be about 0.4:0.6:2=about 1:1.5:5 (i.e., about 1.5 parts Zn-containing salt and about 5 parts Fe-containing salt for every part of the Ni-containing salt, on a molar basis).

Next, the method 350 can include, at step 354, coprecipitating one or more precursor compounds from the solution to produce precipitated precursor particles, wherein the precipitated precursor particles comprise the one or more precursor compounds. After the precipitated precursor particles have been formed, the liquid component of the solution (e.g., the solvent or solvents that form the solution, the one or more surfactants, and any unprecipitated portion of the first and second method salts) and the precipitated precursor particles form a reaction mixture.

In an example, the one or more precursor compounds of the precipitated precursor particles comprises a single compound that includes both the one or more “A” elements and the one or more “B” elements of the spinel formula (i.e., AB₂O₄) that was precipitated from the one or more first salts of the one or more first metal elements and the one or more second salts of the one or more second metal elements—for example, if the first metal salt comprises nickel nitrate and the second metal salt comprises cobalt chloride, the resulting precursor particles can comprise a nickel-doped cobalt hydroxide (Ni-doped Co(OH)₂). In another example, the one or more precursor compounds that form the precipitated precursor particles can include one or more first precursor compounds corresponding to the one or more first metal salts and one or more second precursor compounds corresponding to the one or more second metal salts—for example, if the first metal salt comprises nickel nitrate and the second metal salt comprises cobalt chloride, the one or more precursor compounds could comprise particles of nickel hydroxide (Ni(OH)₂) and particles of cobalt hydroxide (Co(OH)₂) and/or composite particles that include both nickel hydroxide and cobalt hydroxide).

In an example, coprecipitating the precursor particles comprising the one or more precursor compounds from the solution (step 354) comprises adding one or more precipitating agents to the solution that react with the one or more first metal salts and the one or more second metal salts in the solution to form the one or more precursor compounds, wherein the one or more precursor compounds are insoluble or substantially insoluble in the solvent so that they precipitate out of the solution.

In an example, the precipitating agent comprises an alkaline solution, such as a hydroxide compound (such as sodium hydroxide (NaOH), potassium hydroxide (KOH), or tetramethylammonium hydroxide (N(CH₃)₄(OH)), wherein the hydroxide reacts with the one or more first metal salts and the one or more second metal salts to form hydroxide compounds of the one or more first metals that form the one or more first metal salts and second hydroxide compounds of the one or more second metals that form the one or more second metal salts. For example, if the first metal salt comprises a nickel-containing salt (e.g., nickel nitrate (Ni(NO₃)₂) and the second metal salt comprises an iron-containing salt (e.g., iron chloride (FeCl₂)) to form nickel ferrite (NiFe₂O₄), then a first precursor compound can be nickel (II) hydroxide (Ni(OH)₂) and a second precursor compound can be iron (II) hydroxide (Fe(OH)₂).

The inventors have found that for some final spinel particles formed after calcination of the one or more coprecipitated precursor compounds (e.g., in the baking step 364, described in more detail below), the mechanical integrity of the adhesion between the spinel particles and the conductive substrate and uniformity of the overall spinel catalyst coating on the conductive substrate can be affected by the presence of certain compounds in either the salt solution or in the alkaline precipitating agent. For example, if carbonate is present in the hydroxide precipitating agent above a certain threshold, the carbonate present in the coprecipitated precursor particles affects coating uniformity and adhesion integrity (depending on the specific first and second metals). In an example, a carbonate concentration of about 1000 parts per million (ppm) or more in the precipitating agent and/or the salt solution was found to be the threshold at which adhesion and/or coating uniformity was negatively affected. However, the specific carbonate concentration threshold was found to depend on the specific spinel chemistry being produced, such that for some spinel catalyst compounds, the threshold carbonate concentration could be more—e.g., 1050 ppm or more, 1100 ppm or more, 1150 ppm or more, 1200 ppm or more, 1250 ppm or more, 1300 ppm or more, 1350 ppm or more, 1400 ppm or more, 1450 ppm or more, 1500 ppm or more, 1600 ppm or more, 1700 ppm or more, 1750 ppm or more, 1800 ppm or more, 1900 ppm or more, or 2000 ppm or more. Similarly, for other spinel catalyst compounds, a lower carbonate threshold concentration may be necessary, such as 950 ppm, 900 ppm, 850 ppm, 800 ppm, 750 ppm, 700 ppm, 650 ppm, 600 ppm, 550 ppm, or 500 ppm or lower. In an example, if the carbonate concentration is higher than the particular threshold concentration for the spinal compound that is to be formed in one or both of the salt solution or the precipitating agent, the method can include scrubbing the salt solution and/or the precipitating agent of carbonate, such as by sparging nitrogen gas (N₂) into the solution in question, which can act to purge CO₂ from the solution and lower the carbonate concentration.

Precipitating agents other than hydroxides that can be used for the coprecipitation step (step 354) include, but are not limited to, a carbonate compound (such as sodium carbonate (Na₂CO₃) or ammonium carbonate ((NH₄)₂CO₃)), a bicarbonate compound(such as sodium bicarbonate (NaHCO₃) or ammonium bicarbonate (NH₄)HCO₃), a dicarboxylic acid (such as oxalic acid (C₂H₂O₄)), ammonia (NH₃), sodium dodecyl sulfate (CH₃(CH₂)₁₁OSO₃Na), urea (CO(NH₂)₂), and thiourea (CS(NH₂)₂).

Coprecipitating (step 354) can comprise titrating the one or more precipitating agents into the solution comprising the first and second metal salts and the surfactant (e.g., slowly increasing the amount of the precipitating agent added to the solution, such as in a dropwise manner). In an example, the solution can be combined with the one or more precipitating agents until the resulting mixture reaches a specified concentration of the precipitating agent, wherein the specified concentration of the one or more precipitating agents corresponds to reaction and formation of the one or more precursor compounds. In the case where the precipitating agent comprises a hydroxide such as NaOH, the hydroxide can be titrated into the solution until the resulting mixture has a specified pH that is known to result in precipitation of the first and second precursor particles (e.g., a pH of 10 or higher).

In another example, forming the solution (step 352) can comprise forming a first metal salt solution comprising the one or more first metal salts dissolved in a first solvent, such as water, and forming a second metal salt solution comprising the one or more second metal salts dissolved in a second solvent (which can be the same or different from the first solvent). One or both of the first and second metal salt solutions can also include a precipitating agent, such as a hydroxide solution, for example sodium hydroxide (NaOH). Then, during the coprecipitation step (step 354), the first metal salt solution and the second metal salt solution can be combined, such as by titrating the first metal salt solution into the second metal salt solution or vice versa, to initiate coprecipitation by reaction of the precipitating agent and the one or more first metal salts and/or the one or more second metal salts.

Other parameters for the coprecipitation step 354 can include, but are not limited to: a specified pH for the precursor solution, a specified temperature of the precursor solution, or a dosing rate for the introduction of the one or more precipitation agents into the precursor solution (or vice versa for the introduction of the precursor solution into a second solution comprising the one or more precipitation agents), e.g., a titrate rate.

In an example, a specified pH for the precursor solution during the coprecipitation step 354 is from about 10 to about 14, such as from about 11 to about 13, for example from about 11.5 to about 12, such as a pH of about 10, about 10.1, about 10.2, about 10.3, about 10.4, about 10.5, about 10.6, about 10.7, about 10.8, about 10.9, about 11, about 11.1, about 11.2, about 11.3, about 11.4, about 11.5, about 11.6, about 11.7, about 11.8, about 11.9, about 12, about 12.1, about 12.2, about 12.3, about 12.14, about 12.15, about 12.6, about 12.7, about 12.8, about 12.9, about 13, about 13.1, about 13.2, about 13.3, about 13.4, about 13.5, about 13.6, about 13.7, about 13.8, about 13.9, or about 14.

In an example, a specified temperature for the precursor solution during the coprecipitation step 354 is from about 10° C. to about 100° C., such as from about 10° C. to about 90° C., from about 10° C. to about 80° C., from about 10° C. to about 75° C., from about 10° C. to about 70° C., from about 10° C. to about 60° C., or from about 10° C. to about 50° C., for example about 10° C., about 11° C., about 12° C., about 13° C., about 14° C., about 15° C., about 16° C., about 17° C., about 18° C., about 19° C., about 20° C., about 21° C., about 22° C., about 23° C., about 24° C., about 25° C., about 26° C., about 27° C., about 28° C., about 29° C., about 30° C., about 31° C., about 32° C., about 33° C., about 34° C., about 35° C., about 36° C., about 37° C., about 38° C., about 39° C., about 40° C., about 41° C., about 42° C., about 43° C., about 44° C., about 45° C., about 46° C., about 47° C., about 48° C., about 49° C., about 50° C., about 51° C., about 52° C., about 53° C., about 54° C., about 55° C., about 56° C., about 57° C., about 58° C., about 59° C., about 60° C., about 61° C., about 62° C., about 63° C., about 64° C., about 65° C., about 66° C., about 67° C., about 68° C., about 69° C., about 70° C., about 71° C., about 72° C., about 73° C., about 74° C., or about 75° C.

In an example, a dosing rate of the one or more precipitation agents into the precursor solution (or of the precursor solution into the one or more precipitation agents) is from about 0.01 milliliters per minute (mL/min) to about 25 mL/min, such as from about 0.05 mL/min to about 20 mL/min, for example from about 0.1 mL/min to about 15 mL/min, such as from about 0.2 mL/min to about 10 mL/min. Specific examples of dosing rates include, but are not limited to, about 0.01 mL/min, about 0.025 mL/min, about 0.05 mL/min, about 0.075 mL/min, about 0.1 mL/min, about 0.125 mL/min, about 0.15 mL/min, about 0.175 mL/min, about 0.2 mL/min, about 0.225 mL/min, about 0.25 mL/min, about 0.275 mL/min, about 0.3 mL/min, about 0.325 mL/min, about 0.35 mL/min, about 0.375 mL/min, about 0.4 mL/min, about 0.425 mL/min, about 0.45 mL/min, about 0.475 mL/min, about 0.5 mL/min, about 0.525 mL/min, about 0.55 mL/min, about 0.575 mL/min, about 0.6 mL/min, about 0.625 mL/min, about 0.65 mL/min, about 0.675 mL/min, about 0.7 mL/min, about 0.725 mL/min, about 0.75 mL/min, about 0.775 mL/min, about 0.8 mL/min, about 0.825 mL/min, about 0.85 mL/min, about 0.875 mL/min, about 0.9 mL/min, about 0.925 mL/min, about 0.95 mL/min, about 0.975 mL/min, about 1 mL/min, about 1.1 mL/min, about 1.2 mL/min, about 1.3 mL/min, about 1.4 mL/min, about 1.5 mL/min, about 1.6 mL/min, about 1.7 mL/min, about 1.8 mL/min, about 1.9 mL/min, about 2 mL/min, about 2.1 mL/min, about 2.2 mL/min, about 2.3 mL/min, about 2.4 mL/min, about 2.5 mL/min, about 2.6 mL/min, about 2.7 mL/min, about 2.8 mL/min, about 2.9 mL/min, about 3 mL/min, about 3.1 mL/min, about 3.2 mL/min, about 3.3 mL/min, about 3.4 mL/min, about 3.5 mL/min, about 3.6 mL/min, about 3.7 mL/min, about 3.8 mL/min, about 3.9 mL/min, about 4 mL/min, about 4.1 mL/min, about 4.2 mL/min, about 4.3 mL/min, about 4.4 mL/min, about 4.5 mL/min, about 4.6 mL/min, about 4.7 mL/min, about 4.8 mL/min, about 4.9 mL/min, about 5 mL/min, about 5.1 mL/min, about 5.2 mL/min, about 5.3 mL/min, about 5.4 mL/min, about 5.5 mL/min, about 5.6 mL/min, about 5.7 mL/min, about 5.8 mL/min, about 5.9 mL/min, about 6 mL/min, about 6.1 mL/min, about 6.2 mL/min, about 6.3 mL/min, about 6.4 mL/min, about 6.5 mL/min, about 6.6 mL/min, about 6.7 mL/min, about 6.8 mL/min, about 6.9 mL/min, about 7, about 7.1 mL/min, about 7.2 mL/min, about 7.3 mL/min, about 7.4 mL/min, about 7.5 mL/min, about 7.6 mL/min, about 7.7 mL/min, about 7.8 mL/min, about 7.9 mL/min, about 8 mL/min, about 8.1 mL/min, about 8.2 mL/min, about 8.3 mL/min, about 8.4 mL/min, about 8.5 mL/min, about 8.6 mL/min, about 8.7 mL/min, about 8.8 mL/min, about 8.9 mL/min, about 9 mL/min, about 9.1 mL/min, about 9.2 mL/min, about 9.3 mL/min, about 9.4 mL/min, about 9.5 mL/min, about 9.6 mL/min, about 9.7 mL/min, about 9.8 mL/min, about 9.9 mL/min, or about 10 mL/min.

After coprecipitating the one or more precursor compounds as the precipitated precursor particles (step 354), the method 350 can include, at step 356, separating at least a portion of the precipitated precursor particles from the liquid component of the solution. Separating the precipitated precursor particles from the liquid component (step 356) can comprise any method of solid-liquid separation including, but not limited to, filtering the reaction mixture with a filter or screen having a filtration size that is smaller than the expected size of the precipitated precursor particles, centrifugation, and the like. After separating at least the portion of the precipitated precursor particles from the liquid component (step 356), the method 350 can include, at step 358, washing the separated precipitated precursor particles to provide washed precursor particles. In an example, the washing of step 358 can be to remove surfactant from the surfaces of the precipitated precursor particles and/or so that a pH of the washed precursor particles is neutral (e.g., from about 6.5 to about 7.5, e.g., about 7). In an example, the precipitated precursor particles can be washed (step 358) with a washing medium such as, but not limited to, one or any mixture of: water, an alcohol (such as ethanol or isopropanol), or a ketone (such as acetone or methyl ethyl ketone).

After separating the precipitated precursor particles from the liquid component (step 356) and washing the separated precipitated precursor particles (step 358), the method 350 can include, at step 360, forming a slurry of the washed precursor particles, for example by adding the washed precursor particles to a slurry medium, such as, but not limited to, water and/or an alcohol. In an example, the slurry comprises from about 0.4 wt. % to about 25 wt. % total solids of the washed precursor particles, for example from about 0.5 wt. % to about 20 wt. % total solids, such as from about 1 wt. % to about 15 wt. %. In some examples, the slurry formed in step 360 can include one or more other additives (in addition to the precipitated precursor particles and the slurry medium), such as one or both of a thickener (e.g., modified cellulose) to thicken the slurry (such as to a thickened viscosity of from about 1 centipoise (cP) to about 200 cP) and/or a binder (such as a binder sold under the NAFION trade name by The Chemours Co., Wilmington, DE, USA) to improve adhesion to the conductive substrate (in step 362, described below) and/or to improve adhesion between the precursor particles and/or between the final spinel particles (such as by including from about 0 wt. % to about 1 wt. % in the slurry).

Next, the method 350 can include, at step 362, applying the slurry to one or more surfaces of a conductive substrate (such as one of the example electrodes 300 described above with respect to FIGS. 4-9) to provide a slurry coated substrate. Applying the slurry to the conductive substrate (step 362) can be performed with any method capable of applying a slurry onto the conductive substrate, which can include, but is not limited to, one or more of: dip coating the conductive substrate with the slurry, painting the one or more surfaces of the conductive substrate with the slurry, spraying the slurry onto the one or more surfaces of the conductive substrate, applying the slurry with a doctor blade, slot-die coating of the slurry onto the conductive substrate (with or without a tensioned web), or by comma coating of the conductive substrate. The method 350 of the present disclosure does not require any specialized methods to pattern or template the slurry when applying it to the conductive substrate, e.g., so that the final particles formed have a desired size and/or shape. In other words, the method 350 of the present disclosure is capable of forming nanosized particles (e.g., particles that are about 500 nm or less, for example about 200 nm or less) without having to use templating or other specialty methods of patterning the slurry onto the conductive substrate.

In an example, the thickness of the slurry layer that has been coated onto the conductive substrate can be from about 0.5 micrometers (μm) to about 25 μm, such as from about 1 μm to about 20 μm, for example from about 2 μm to about 17.5 μm, such as from about 5 μm to about 5 m. In an example, the coating layer of the slurry on the conductive substrate is no more than about 10 wt. % water before performing the baking step (step 364, described below), for example no more than about 9 wt. % of the slurry coating being water, no more than about 8 wt. % being water, no more than about 7.5 wt. % being water, no more than about 7 wt. % being water, no more than about 6.5 wt. % being water, no more than about 6 wt. % being water, no more than about 5.5 wt. % being water, no more than about 5 wt. % being water, no more than about 4.5 wt. % being water, no more than about 4 wt. % being water, no more than about 3.5 wt. % being water, no more than about 3 wt. % being water, or no more than about 2.5 wt. % being water.

In an example, the conductive substrate onto which the slurry is coated can comprise any conductive material that is useful as an electrode for an electrolyzer, such as the example hydrogen gas electrolyzer 100 described above with respect to FIG. 1. Examples of materials from which the conductive substrate can be formed include, but are not limited to, nickel metal (Ni), titanium metal (Ti), a steel material (such as a low-alloy steel, stainless steel, or carbon steel), gold metal (Au), a conductive carbon-based material (such as a carbon cloth, a carbon fiber, a plurality of carbon rods, or graphite), and copper metal (Cu).

After coating the one or more surface of the conductive substrate with the slurry (step 362), the method 350 can include, at step 364, baking the slurry coated substrate at specified calcination conditions to convert the one or more precursor compounds in the washed precursor particles to spinel particles to provide a spinel coated substrate. The specified calcination conditions convert the one or more precursor compounds to spinel particles (i.e., particles having a spinel crystal structure with the general formula AB₂O₄ as described above). In an example, the specified calcination conditions are such that the one or more “B” metal elements in the spinel chemical formula are oxidized from an oxidation state of +2 to an oxidation state of +3 during the baking step 364. The specified calcination conditions of the baking step 364 can also be selected to remove residual surfactant (if present in the precipitation solution) that was not removed by the optional washing step 358.

The nature of the slurry coating and the calcination conditions of the baking step 364 are such that the spinel particles are adhered directly to the one or more surfaces of the conductive substrate (such as the example spinel particles 316 that are adhered to the substrate 312 as shown in FIG. 10).

In an example, the specified calcination conditions can include one or more of: a specified calcination temperature; a specified baking time; a specified pressure during the baking step 364; a specified ramp-up rate of the temperature during the baking step 364 (including “no ramp-up” where the oven is heated directly up to the specified calcination temperature as quickly as possible), a specified ramp-down rate of the temperature during the baking step 364 (including “no ramp-down” where the oven is cooled is quickly as possible back down to or near room temperature), and a specified atmosphere (e.g., the gas or gasses that are present around the slurry coated substrate during the baking step 364).

In an example, the specified calcination temperature for the baking of the slurry coated substrate (step 364) can be a relatively low temperature, compared to temperatures that have been required for previous methods of forming spinel materials. For example, previous spinel producing processes have required temperatures of 400° C. or higher in order to achieve nano-sized spinel features and relatively high catalytic activity, such as from about 500° C. to about 700° C. In an example, the specified calcination temperature for the baking step 364 can be about 400° C. or less, for example about 395° C. or less, about 390° C. or less, about 385° C. or less, about 380° C. or less, about 375° C. or less, about 370° C. or less, about 365° C. or less, about 360° C. or less, about 355° C. or less, about 350° C. or less, about 345° C. or less, about 340° C. or less, about 335° C. or less, about 330° C. or less, or about 325° C. or less. In an example, the specified calcination temperature for the baking step 364 is from about 200° C. to about 325° C.

In an example, the specified baking time for the baking of the slurry coated substrate (step 364) is long enough so that the spinel structure will be formed from the conversion of the precursor particles in the slurry to spinel particles. In an example, the specified baking time is from about 0.5 hours to about 5 hours, such as from about 1 hour to about 3 hours.

In an example, the specified pressure during the baking of the slurry coated substrate (step 364) can be relatively low compared to pressures that have been required for previous methods of forming spinel materials. For example, previous spinel producing processes have required high pressures (e.g., high enough for solvothermal synthesis of spinel materials) in order to achieve nano-sized spinel features, relatively high catalytic activity, and/or so that the electrocatalyst material will be deposited and adhered directly on the electrode substrate. In the method 350, the specified pressure during the baking step 364 can be relatively low, for example at atmospheric pressure or slightly above, such as from about 1 atmosphere (atm) to about 2 atm.

In an example, the baking of the slurry coated substrate (step 364) can be performed in a regular atmosphere (i.e., in the presence of oxygen or ambient air) such that an inert atmosphere (e.g., in the presence of a high concentration of nitrogen gas or other inert gas) is not required.

In the method 350, neither the step of applying the slurry to the conductive substrate (step 362) nor the step of baking the slurry coated substrate (step 364) require the use of specialized methods to ensure that the size of the resulting electrocatalyst structures (i.e., the spinel particles formed after baking the slurry coated substrate (step 364)) are nano-sized particles, e.g., particles with a largest size that is less than or equal to about 900 nm, for example less than or equal to about 750 nm, such as less than or equal to about 500 nm. For example, the method 350 does not require the use of templating, ion etching, or any other specialized methods to ensure the small size of the spinel particles. Without wishing to be bound by this theory, the inventors believe this can occur because the inclusion of the surfactant in the salt solution including one or more first salts comprising nitrate salts and one or more second salts comprising chloride salts (or vice versa, one or more first salts comprising chloride salts and one or more second salts comprising nitrate salts) (step 352) acts as a kind of solution-based template during the formation of precursor particles during the step of coprecipitating the one or more precursor compounds from the solution (step 354), such that the precipitated precursor particles have a nanoscale size. The nanoscale precursor particles then ensure that the spinel particles that are formed during the baking of the slurry coated substrate (step 364) are also nanoscale sized particles.

The spinel coated substrate that is formed by the method 350 can have many advantages over previous methods of forming spinel catalysts. First, because the spinel particles are grown directly on the conductive substrate during the baking of the slurry coated substrate (step 364), there is little to no loss of active sites or conductivity in the substrate because a binder or adhesive was not needed to adhere the catalyst material to the substrate and as such there is no binder or adhesive material to block the active sites on the catalyst particles or to interfere with conductivity of the substrate. Second, the method 350 allows the nanosized spinel particles to be formed and deposited on the conductive substrate without using templating, high pressures, or an inert atmosphere, which can all add to the complexity and expense of the process. Third, the relatively low specified calcination temperature during the baking of the slurry coated substrate (step 364) avoids oxidation of the material of the conductive substrate (e.g., nickel substrates will be converted to nickel oxide at calcination temperatures of about 400° C. or higher). The ability to form a spinel catalyst coating at a lower calcination temperature also allows for a wide range of electrode substrate materials that may not be feasible if higher calcination temperatures were required. For example, the method of the present disclosure could conceivably be used to form spinel catalyst coatings on materials that are commonly used to form electrodes including, but not limited to: titanium (having maximum service temperature of around 400° C.), gold (having a maximum service temperature of from about 130° C. to about 220° C.), carbon paper (having a maximum service temperature of around 400° C.), and copper (having a maximum service temperature of from about 180° C. to about 300° C.).

### EXAMPLES

Various embodiments of the present invention can be better understood by reference to the following Examples which are offered by way of illustration. The present invention is not limited to the Examples given herein.

### Comparative Example 1

Catalyst particles comprising nickel cobaltite spinel (NiCo₂O₄) were formed by preparing a solution of nickel nitrate and cobalt nitrate without the use of a surfactant and coprecipitating precursor particles from the nitrate solution, followed by calcination of the precipitated precursor particles at 325° C. for about 1-3 hours.

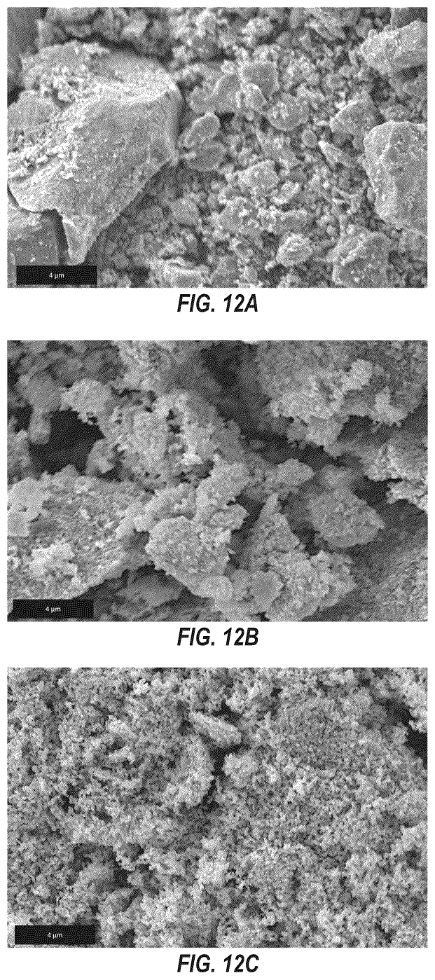

The resulting catalyst particles are shown in the scanning electron microscopy (SEM) image of FIG. 12A. As can be seen in FIG. 12A, the catalyst particles formed by coprecipitating from a nitrate-only solution followed by calcination resulted in the average particle size of the catalyst particles being several microns in size.

### Comparative Example 2

Catalyst particles comprising nickel cobaltite spinel (NiCo₂O₄) were formed by preparing a solution of nickel nitrate and cobalt nitrate that included poly(ethylene glycol) surfactant and coprecipitating precursor particles from the nitrate and surfactant solution, followed by calcination of the precipitated precursor particles at 325° C. for about 1-3 hours.

The resulting catalyst particles are shown in the SEM image of FIG. 12B. As can be seen in FIG. 12B, there is little to no noticeable change in particle size when adding the surfactant to the nitrate solution during the coprecipitation step.

### Example 3

Catalyst particles comprising nickel cobaltite spinel (NiCo₂O₄) were formed by preparing a solution of nickel nitrate and cobalt chloride and poly(ethylene glycol) surfactant. Precursor particles were coprecipitated from the nitrate/chloride and surfactant solution, followed by calcination of the precipitated precursor particles at 325° C. for about 1-3 hours, in accordance with the method of the present disclosure.

The resulting catalyst particles are shown in the SEM image of FIG. 12C. As can be seen in FIG. 12C, when a mixture of nitrate and chloride salts is coprecipitated in the presence of a surfactant, the average particle size for the catalyst particles after calcination was noticeably smaller, about 200 nm, and nanometer scale features were also observed.

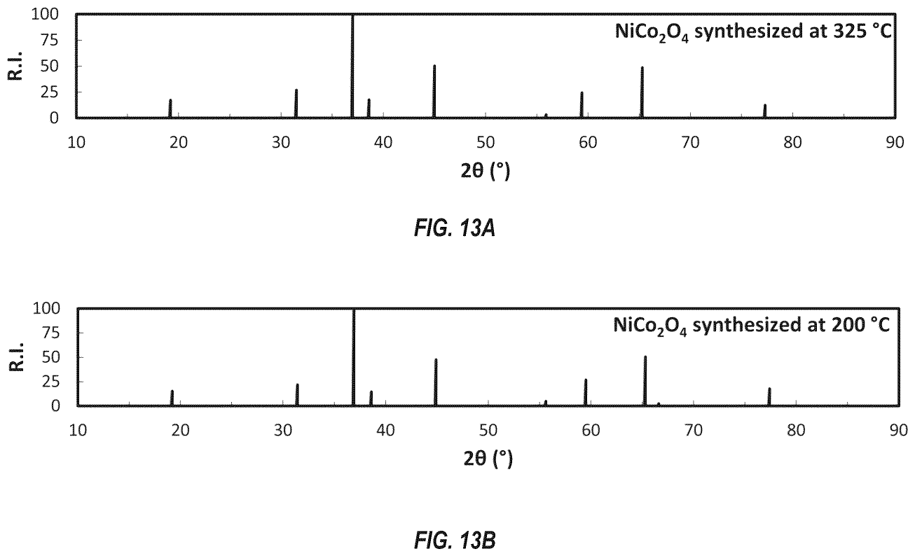

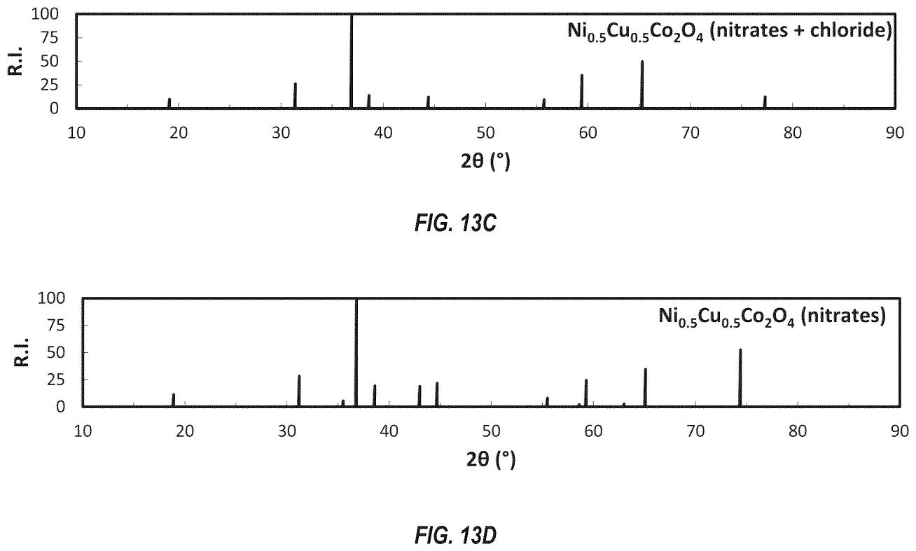

FIG. 13A is an X-ray diffraction (XRD) fitting pattern from the particles formed by EXAMPLE 3. The XRD pattern of FIG. 13A substantially matches the standard XRD pattern (obtained from the International Centre for Diffraction Data (ICDD)) for cobalt (II, III) oxide (Co₃O₄). Cobalt (II, III) oxide is well known as comprising the normal spinel structure, which verifies the successful formation of a spinel structure nickel cobaltite via calcination at 325° C. for the method of EXAMPLE 3.

### Example 4

Catalyst particles comprising nickel cobaltite spinel (NiCo₂O₄) were formed by a method that was nearly identical to the method described above for EXAMPLE 3, except that the calcination of the precipitated precursor particles was carried out at 200° C. instead of at 325° C.

FIG. 13B is an XRD fitting pattern from the particles formed by EXAMPLE 4. Like the XRD pattern of FIG. 13A, the XRD pattern of FIG. 13B substantially matches the standard XRD pattern for cobalt (II, III) oxide (Co₃O₄), which verifies the successful formation of a spinel structure nickel cobaltite via calcination at both 325° C. (EXAMPLE 3) and at the substantially lower temperature of 200° C. (EXAMPLE 4).

### Example 5

Nickel copper cobaltite (Ni_{0.5}Cu_{0.5}Co₂O₄) particles were formed by preparing a solution of nickel nitrate, copper nitrate, and cobalt chloride that included poly(ethylene glycol) surfactant and coprecipitating precursor particles from the nitrate and surfactant solution, followed by calcination of the precipitated precursor particles at 325° C. for about 3 hours. The method of EXAMPLE 5 is similar to the method of EXAMPLE 3, except that both nickel nitrate and copper nitrate are included in the solution so that the resulting spinel structure will be nickel copper cobaltite rather than nickel cobaltite.

FIG. 13C is an XRD fitting pattern from the particles formed by EXAMPLE 5. Like the XRD patterns of FIGS. 13A and 13B, the XRD pattern of FIG. 13C substantially matches the standard XRD pattern for cobalt (II, III) oxide (Co₃O₄), which verifies the successful formation of a spinel structure nickel copper cobaltite via the method of EXAMPLE 5. The XRD patterns of FIG. 13A-13C also verify that the presence of a surfactant in the coprecipitation solution does not interfere with the formation of a spinel structure.

### Comparative Example 6

Nickel copper cobaltite (Ni_{0.5}Cu_{0.5}Co₂O₄) particles were formed by preparing a solution of nickel nitrate, copper nitrate, and cobalt nitrate that included poly(ethylene glycol) surfactant and coprecipitating precursor particles from the nitrate and surfactant solution, followed by calcination of the precipitated precursor particles at 325° C. for about 3 hours. The method of COMPARATIVE EXAMPLE 6 is nearly identical to the method of EXAMPLE 5, except that only nitrate salts were used to form the solution instead of nitrates and chloride as in EXAMPLE 5.

FIG. 13D is an XRD fitting pattern for the particles formed by COMPARATIVE EXAMPLE 6. The XRD pattern of FIG. 13D shows the formation of secondary oxide peaks, which are believed to be from the formation of NiO (e.g., when the XRD pattern of FIG. 13D is also compared to the ICDD standard XRD pattern for nickel oxide (NiO)). The presence of NiO indicates further oxidation has occurred, which can result in a loss of electrode conductivity. The formation of the NiO peaks in the XRD pattern of FIG. 13D highlights the potential importance of using a mixed nitrate and chloride solution to form the coprecipitated precursor particles.

### Comparative Example 7

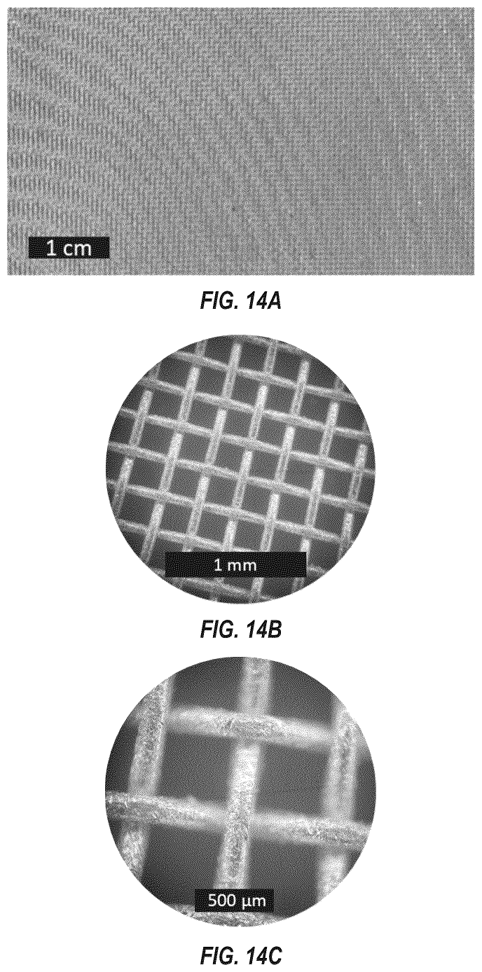

An uncoated nickel mesh electrode substrate was used for comparison purposes. FIGS. 14A-14C show optical images of the uncoated nickel mesh electrode at a macro level (FIG. 14A), through an optical microscope at a magnification of four times (4×) (FIG. 14B), and through the optical microscope at a magnification of ten times (10×) (FIG. 14C).

### Comparative Example 8

A nickel mesh electrode substrate that is identical to the uncoated nickel mesh electrode of COMPARATIVE EXAMPLE 7 was coated with a calcinated nickel cobaltite powder material via a conventional spray coating method. The nickel cobaltite powder was prepared following the method of the present disclosure, but by performing the calcinating baking step in a crucible separate from the nickel mesh substrate, then grinding the resulting nickel cobaltite to a powder. An ink was prepared by dispersing the powder in a mixture of deionized water, alcohol, and a binder. The ink was sprayed onto the nickel mesh substrate.

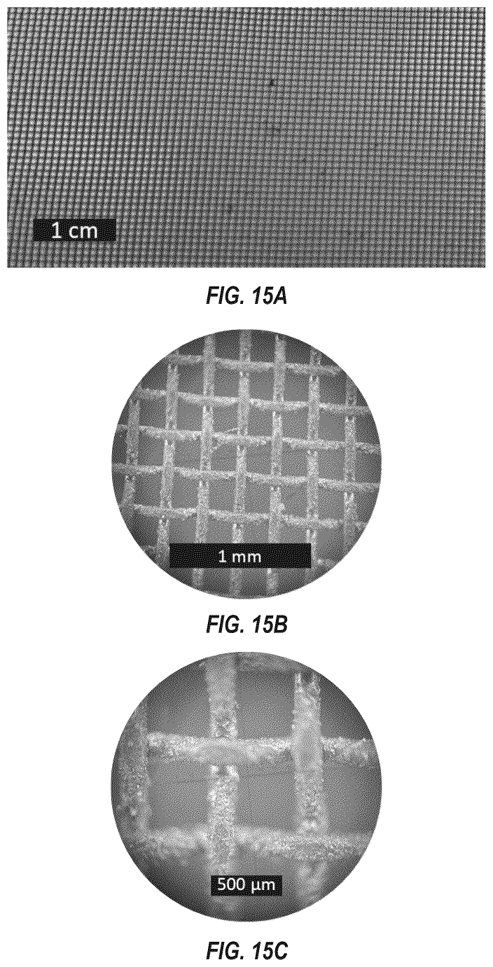

FIGS. 15A-15C show optical images of the conventionally spray coated nickel mesh electrode at a macro level (FIG. 15A), through the optical microscope at four times (4×) magnification (FIG. 15B), and through the optical microscope at ten times (10×) magnification (FIG. 15C).

### Example 9

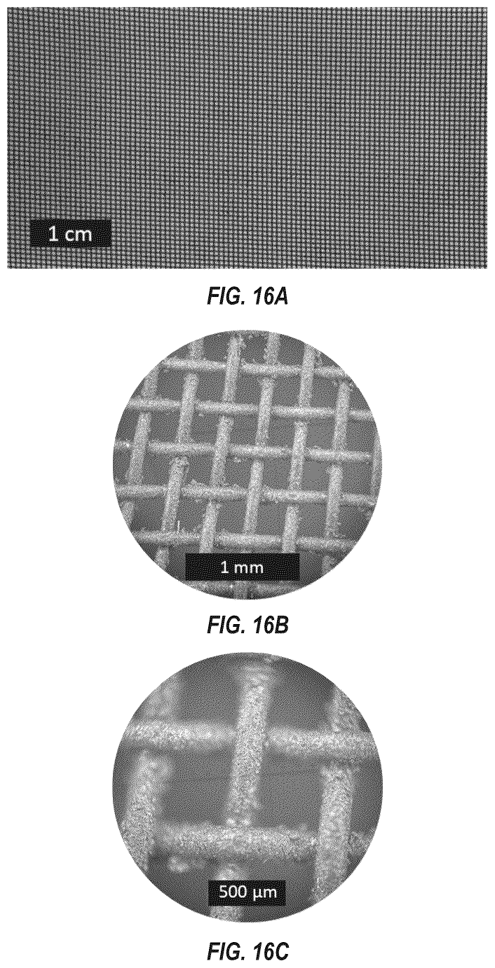

An uncoated nickel mesh electrode substrate that is identical to the uncoated nickel mesh electrode of COMPARATIVE EXAMPLE 7 was coated with nickel cobaltite spinel via the method 350 described above. FIGS. 16A-16C show optical images of the nickel electrode coated by the method of the present disclosure at a macro level (FIG. 16A), through the optical microscope at four times (4×) magnification (FIG. 16B), and through the optical microscope at ten times (10×) magnification (FIG. 16C).

The optical images of FIGS. 16A-16C (directly baking the nickel cobaltite onto the nickel mesh substrate according to the method of the present disclosure) compared to FIGS. 15A-15C (conventional spray coating) show that directly baking nickel cobaltite onto the substrate as in EXAMPLE 9 produces a more uniform catalyst coating. This was confirmed with tape testing, which demonstrated excellent adhesion compared to the conventionally sprayed electrode of COMPARATIVE EXAMPLE 8.

TABLE 1, below, are the normalized through plane resistance measured for various electrodes. The baseline value is for an uncoated nickel mesh electrode (e.g., the nickel mesh electrode of COMPARATIVE EXAMPLE 7). The uncoated nickel mesh electrode was baked at 325° C. and at 700° C. Baking the uncoated nickel electrode at 700° C. results in a large increase in resistance (about a forty times (40×) increase, or greater than a 4000% increase), which was believed to be due to nickel oxide (NiO) forming at higher temperatures. The formation of NiO was confirmed by comparing an XRD pattern for the uncoated electrode baked at 325° C. and at 700° C. to the ICDD standard XRD pattern for NiO, which confirmed the presence of NiO.

TABLE 1
Normalized Through-Plane Resistance of Nickel Electrodes

| | Normalized Through-Plane |
|---|---|
| Electrode | Resistance (Ω cm²) |
| Uncoated Ni Electrode (Baseline) | 0.00254 |
| Uncoated Ni baked at 325° C. | 0.00757 |
| Uncoated Ni baked at 700° C. | 0.10549 |
| Ni directly coated with NiCo₂O₄ and | 0.08146 |
| baked at 325° C. | |
| Ni spray coated with NiCo₂O₄ and | 4.48739 |
| baked at 325° C. | |

Baking nickel cobaltite directly onto the nickel mesh substrate at 325° C. according to the methods of the present disclosure (i.e., the coated electrode formed in EXAMPLE 9) results in a minor increase in resistance (e.g., about an increase from 0.00757 Ω/cm² to 0.08146 Ω/cm², or an increase of 0.07389 Ω/cm²), which is to be expected since spinel forms of nickel cobaltite are non-electrically conductive. However, the resistance of an electrode coated by the method of the present disclosure is still substantially lower than an electrode coated by conventional spray coating of nickel cobaltite (i.e., the coated electrode formed in COMPARATIVE EXAMPLE 8) and is also lower than any electrode that is baked at 700° C. The much higher resistance of the spray coated electrode is believed to be due to the addition of a binder and the resulting poor electrical contact between the catalyst and the substrate.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

Method examples described herein can be machine or computer-implemented at least in part. Some examples can include a computer-readable medium or machine-readable medium encoded with instructions operable to configure an electronic device to perform methods as described in the above examples. An implementation of such methods can include code, such as microcode, assembly language code, a higher-level language code, or the like. Such code can include computer readable instructions for performing various methods. The code may form portions of computer program products. Further, in an example, the code can be tangibly stored on one or more volatile, non-transitory, or non-volatile tangible computer-readable media, such as during execution or at other times. Examples of these tangible computer-readable media can include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

1. A method comprising:
coprecipitating one or more precursor compounds from a precursor solution comprising one or more first metal salts and one or more second metal salts to produce precipitated precursor particles;
forming a slurry of the precipitated precursor particles;
applying the slurry to one or more surfaces of a conductive substrate to provide a slurry coated substrate; and
baking the slurry coated substrate at specified calcination conductions to convert the one or more precursor compounds of the precipitated precursor particles to spinel particles that are adhered to the one or more surfaces of the conductive substrate, wherein the spinel particles comprise a spinel with the general chemical formula AB₂O₄.

2. The method of claim 1, wherein the spinel particles are adhered directly to the one or more surfaces of the conductive substrate without a binder or adhesive.

3. The method of claim 1, wherein the specified calcination conditions comprise one or both of: a specified calcination temperature of about 400° C. or less and a specified pressure of 2 atmospheres or less.

4. The method of claim 1, wherein the specified calcination conditions comprise a specified calcination temperature of from about 200° C. to about 325° C.

5. The method of claim 1, wherein the specified calcination conditions comprise a baking time of from about 0.5 hours to about 5 hours.

6. The method of claim 1, wherein the precursor solution has a pH of from about 10 to about 12 and/or a temperature of from about 10° C. to about 50° C. during the coprecipitating.

7. The method of claim 1, wherein the coprecipitating comprises adding one or more precipitating agents to the precursor solution.

8. The method of claim 1, wherein the precursor solution further comprises a surfactant.

9. The method of claim 8, wherein the surfactant comprises one or more of: polyethylene glycol, polyethylene glycol dodecyl ether, and oleic acid.

10. The method of claim 1, wherein the one or more first metal salts comprise one or more first salts of A and the one or more second metal salts comprise one or more second salts of B.

11. The method of claim 10, wherein the one or more first salts and the one or more second salts each comprise at least one of a metal nitrate, a metal acetate, a metal sulfate, or a metal halide, and wherein the one or more first salts are different from each of the one or more second salts.

12. The method of claim 1, wherein the one or more first metal salts comprise one or more first salts of B and the one or more second salts comprise one or more second salts of A.

13. The method of claim 12, wherein the one or more first salts and the one or more second salts each comprise at least one of a metal nitrate, a metal acetate, a metal sulfate, or a metal halide, and wherein the one or more first salts are different from each of the one or more second salts.

14. The method of claim 1, wherein A includes one or more of nickel (Ni), zinc (Zn), copper (Cu), cobalt (Co), iron (Fe), lithium (Li), magnesium (Mg), calcium (Ca), barium (Ba), manganese (Mn), germanium (Ge), cadmium (Cd), lanthanide (La), yttrium (Y), chromium (Cr), molybdenum (Mo), ruthenium (Ru), and iridium (Ir).

15. The method of claim 1, wherein B includes one or more of cobalt (Co), iron (Fe), chromium (Cr), aluminum (Al), manganese (Mn), nickel (Ni), gallium (Ga), selenium (Se), molybdenum (Mo), ruthenium (Ru), sulfur (S), and tellurium (Te).

16. An electrode composite comprising:
a conductive substrate; and
a catalyst coating comprising spinel particles adhered directly to one or more surfaces of the conductive substrate without the use of a binder or adhesive, wherein the spinel particles comprise a spinel with the general chemical formula AB₂O₄.

17. The electrode composite of claim 16, wherein A includes one or more of nickel (Ni), zinc (Zn), copper (Cu), cobalt (Co), iron (Fe), lithium (Li), magnesium (Mg), calcium (Ca), barium (Ba), manganese (Mn), germanium (Ge), cadmium (Cd), lanthanide (La), yttrium (Y), chromium (Cr), molybdenum (Mo), ruthenium (Ru), and iridium (Ir).

18. The electrode composite of claim 16, wherein B includes one or more of cobalt (Co), iron (Fe), chromium (Cr), aluminum (Al), manganese (Mn), nickel (Ni), gallium (Ga), selenium (Se), molybdenum (Mo), ruthenium (Ru), sulfur (S), and tellurium (Te).

19. The electrode composite of claim 16, wherein the conductive substrate comprises one or more of: nickel metal, titanium metal, steel, gold metal, copper metal, and a conductive carbon-based material.

20. The electrode composite of claim 16, wherein the conductive substrate comprises a mesh.
